(19) United States
(12) Patent Application Publication
(10) Pub. No.: US 2014/0215297 A1
(43) Pub. Date: Jul. 31, 2014

(54) FILE FORMATS AND METHODS FOR REPRESENTING DOCUMENTS

(71) Applicant: David GROSFELD, New York, NY (US)

(72) Inventor: David GROSFELD, New York, NY (US)

(21) Appl. No.: 14/169,147

(22) Filed: Jan. 30, 2014

Related U.S. Application Data
(60) Provisional application No. 61/758,748, filed on Jan. 30, 2013.

(51) Int. Cl. G06F 17/21

(52) U.S. Cl. CPC G06F 17/211
USPC 715/209

(57) ABSTRACT

This patent describes a method for representing documents for use in a computer application. The purpose of these documents is to contain information such as text, numbers, dates, images, visual compositions, formulas, charts and tables. A key feature of this method is the structuring of such documents as linked, but independent modular subunits, which are exposed to the user as subunits that can be manipulated. The representation method described here confers advantages to such documents not found in existing representation approaches, including the ability to easily combine content from multiple documents, create networks of references among information subunits, and reuse and compute information through expressions.

### CROSS REFERENCE TO RELATED APPLICATION

The present application is a Non-Provisional application of U.S. Provisional Application Ser. No. 61/758,748, filed on Jan. 30, 2013, and claims priority to that application. The contents of those applications are incorporated herein by reference.

### BACKGROUND OF THE INVENTION

A large majority of information exchanged today in the academic and professional worlds is in the form of electronic documents—documents primarily produced in Microsoft Word, PowerPoint and Excel (i.e., Microsoft Office); and analogous applications in Apple's iWork suite, Apache OpenOffice, Google Docs and similar “office” application suites. The methods for representing information used by these applications have significant disadvantages which this invention was developed to address.

To understand the aims of the present invention, one must understand the development of document formats and methods of editing such documents. The earliest electronic documents were entirely text based, and allowed a user to encode information as a series of ASCII characters. One of the key subsequent advances in electronic documents was the development of compound documents, which are text documents that allow non-text content to be embedded within the flow of the document. Such non-text content can include images, tables, charts, audio, video and more. This technology began to be developed in the late 1980s, as personal computers became more powerful and graphic windowing operation system (such as Windows and Mac OS) became standard on personal computers.

The earliest technology frameworks for compound documents included Microsoft's Dynamic Data Exchange (1987) OLE (Object Linking and Embedding, 1990) framework and Apple's OpenDoc format (1992). The primary objective of both of these technologies was to allow documents to contain parts which were created and editable by an application other than the application used to edit the containing document. The goal of both frameworks was to have a compound document that would allow content from different applications to be embedded within it, yet provide the user with a seamless editing experience.

At around the same time, the concept of the “office application suite” started to come into existence. An office suite would at the very minimum include a word processor, spreadsheet program and presentation program. This was the result of the bundling of three disparate applications that were frequently used in the office setting. Two early examples included Microsoft Works (released in 1988) and ClarisWorks/Appleworks (released in 1991). Both of these integrated a word processor, spreadsheet, and presentation application (and other programs) as modules within a single application. Subsequent office suites (Microsoft Office, Novel PerfectOffice, Corel WordPerfect Suite, Oracle StarOffice, Apple iWorks and more) are structured as three or more distinct applications, each with their own file formats, but with a high degree of interoperability and user interface commonality. At the same time, compound document technology was extended to documents such as spreadsheets and presentations.

The early formats used to encode office documents were binary and sometimes proprietary. In the early 2000's, XML document formats started entering into use. The first were the Microsoft Office XML formats (introduced in 2003) and the Open Document Formats (2005), followed by Open Office XML (2007) which is now in widespread use.

The importance of these developments are the following:
(a) Office application suites available in the market have converged to a model of a suite of bundled but independent applications, at the minimum including a word processor, spreadsheet and presentation application
(b) The application office suites available use at least three different file formats, one for word processing, one for spreadsheets and one for presentations, and these file formats enable any of these documents to be a compound document, i.e. have content from a different application (either one of the other applications in the suite or external applications) embedded within in it.

The office suite products available today address several of the key needs of the typical user. They provide applications that allow the user to create word processing, spreadsheet and presentation documents. They also provide the capability to create compound documents which can have parts of different content types or even entire documents embedded within them. Finally their formats are standardized and based on XML, which allows for better interoperability among products made by different manufacturers and allows any program that can read XML to process the contents of such files. However, there are still drawbacks associated with the current office suite model and user needs which remain unmet:
(a) A universal document format: The current approach forces a user to select an initial document type (i.e. word processing, presentation or spreadsheet). Each document type is specialized for one type of content (word processing—flowing text; presentation—visual compositions; spreadsheets—cell based, tabular layouts). If a user wants to combine multiple types of content into one document, they must use inconvenient workarounds. Typically, an individual will have to work with more than one type of document in the course of a project, and thus will spend time having to go back and forth among different applications and manually transferring information from one document to another. This activity, in results in the expenditure of untold work hours every year and is the cause of many errors.
(b) Creating relationships among document parts: Today's office documents (word processing, spreadsheets or presentations) provide a very limited functionality for allowing the user to define relationships between parts of the document. In order to do this, the user must first be able to define logical parts of a document, potentially assigning these parts unique identifiers. The importance of defining distinct parts of a document is that it allows the user to do several things:

(i) Define a logical organization for the document content

(ii) Associate metadata with distinct parts of the document (described in NEC patent U.S. Pat. No. 5,950,215)

(iii) Store multiple versions of parts of the document within the document (described in Xerox patent U.S. Pat. No. 7,171,618)
(c) Reuse content within the document. This shortcoming of current office document formats is acknowledged in Microsoft's patent U.S. Pat. No. 7,617,229, which describes a method for breaking an existing document into components that can be edited separately, but does not describe allowing a user to build a document up from individual parts. Similarly, there are many patents for “modular” document formats (Microsoft's U.S. Pat. No. 7,359,902, U.S. Pat. No. 7,617,451, U.S.20070022128 and more). However it must be noted that these approaches describe formats that are modular from the perspective of the applications that read and process the formats, not how the user interacts with the content in the document.
(d) Flexible approach to viewing a document: The current approach to text based documents is to present the document content in a linear layout. If a user wants to compare sections of content that are separated within the document, he must scroll back and forth. Similarly, in presentation documents, if a user wants to compare slides at different places in the document, they must scroll back and forth. In spreadsheets, a user can only work and edit with one spreadsheet tab at a time.
(e) Packaging tabular data with text and visual content within the same document: A user may want to create and manage data separately from its final presentation format, because it's easier to edit and work with data that is unencumbered by presentation formatting. At the same time, the user may want to package this data along with visual content (such as slides or text) in which the data is presented in the same document, rather than have the data stored in a separate document. Methods for doing this with current technology is described in Microsoft patent U.S.20060150085 A1, Adobe patent U.S. Pat. No. 7,984,374 B2 and Sun patent U.S. Pat. No. 7,155,449.
(f) Integration of computations anywhere within visual content: A user may want to integrate computed elements (individual values, lists or tables) within the flow of text or in a presentation slide. While this is possible in some current applications, it is inconvenient and probably not frequently used. This shortcoming is recognized in Microsoft patent U.S. Pat. No. 7,702,998 for integrating spreadsheet fields in text, Microsoft patent U.S. Pat. No. 5,630,126 for integrating spreadsheets and word processing tables, and IBM patent U.S. Pat. No. 5,630,126 for integrating computations into compound documents.

The document model that we rely on today is obsolete. It is based on the model of the “office application suite”, which at its core forces the user to choose from one of three specialized formats. This model originated over 20 years ago, and it does not fully serve the modern needs of users today.

### SUMMARY

It is an object of the invention to provide a document format capable of containing a plurality of data types. A document format under this model will be natively processed without the need to call multiple applications. This in turn offers the advantage of interoperability of mixed data types and integration of complex data types (e.g. computations) with simple data types (e.g. plain text).

It is another object of the invention to provide a user-accessible document structure comprised one or more document parts containing subunits of content data, and that allows for relationships to be created among document parts. This document structure further allows for the logical organization of the document content. It also allows for the reuse of content within the document.

It is yet another object of the invention to provide a user interface with flexible document view options.

### FIGURES

This invention is described with particularity in the appended claims. The above and further aspects of this invention may be better understood by referring to the following description in conjunction with the accompanying figures. The drawing figures depict one or more implementations in accord with the present teachings by way of illustrative example only, not by way of limitation.

FIG. 1 illustrates a computing system architecture representing computer hardware utilized and provided by various embodiments of the invention.

FIG. 2 provides a visual representation of an Object.

FIG. 3 illustrates relationship established within a document using a single Reference item.

FIG. 4 illustrates an array of Reference items in a document.

FIG. 5A illustrates a Composition in StackPanel layout mode

FIG. 5B illustrates a Composition in WrapPanel layout mode

FIG. 5C illustrates a Composition in Grid layout mode.

FIG. 5D illustrates a Composition in Canvas layout mode.

FIG. 6 illustrates a Composition resembling the visual presentation of a word processing document.

FIG. 7 illustrates Composition resembling the visual presentation of presentation document.

FIG. 8 illustrates a Composition using multiple nested Compositions.

FIG. 9 illustrates a RichText value.

FIG. 10 illustrates the use of keys to retrieve values for an expression.

FIG. 11 illustrates the use of a Reference to retrieve a value.

FIG. 12 illustrates Dereferencing an array of Reference values.

FIG. 13 illustrates Retrieving a value through a direct Object reference.

FIG. 14 illustrates operator expressions with operands having multiplicities of single and array

FIG. 15 illustrates a function that accepts both a single value and an array as an argument

FIG. 16 illustrates a chart with a series whose mode is array of Reference.

FIG. 17 illustrates a chart with a series whose mode is discrete arrays.

FIG. 18 illustrates a DataTable value specified using an array of Reference.

FIG. 19 illustrates a DataTable whose mode is discrete arrays.

FIG. 20 illustrates a visual representation of an Object within an exemplary user interface.

FIG. 21 illustrates a visual representation of Multiple Objects that comprise a document within an exemplary user interface.

FIG. 22 illustrates a visual representation of a single relationship established within a document using a single Reference item within an exemplary user interface.

FIG. 23 illustrates a visual representation of an array of relationships established within a document using an array of Reference items in a document.

FIG. 24 illustrates an exemplary user interface of an application used to edit documents described.

FIG. 25 provides a process workflow for a method for generating a text representation of an Object.

FIG. 26 illustrates an example of an Object encoded as a text representation.

FIG. 27 provides a process workflow for a method for representing a document comprised of a collection of objects.

FIG. 28 provides a process workflow for encoding a Composition into a text based format.

FIG. 29 illustrates an example of a Composition member and its encoding.

FIG. 30 provides a process workflow for encoding RichText into a text based format.

FIG. 31 illustrates an example of a RichText value and its text based encoding.

FIG. 32 illustrates an example of an Object where some members have expressions, and how that object is encoded.

FIG. 33 provides a process workflow for encoding a Chart value as a text representation.

FIG. 34 illustrates an example of a Chart and its encoding.

FIG. 35 provides a process workflow for encoding DataTable value as a text representation.

FIG. 36 illustrates an example of a DataTable and its encoding.

### DETAILED DESCRIPTION

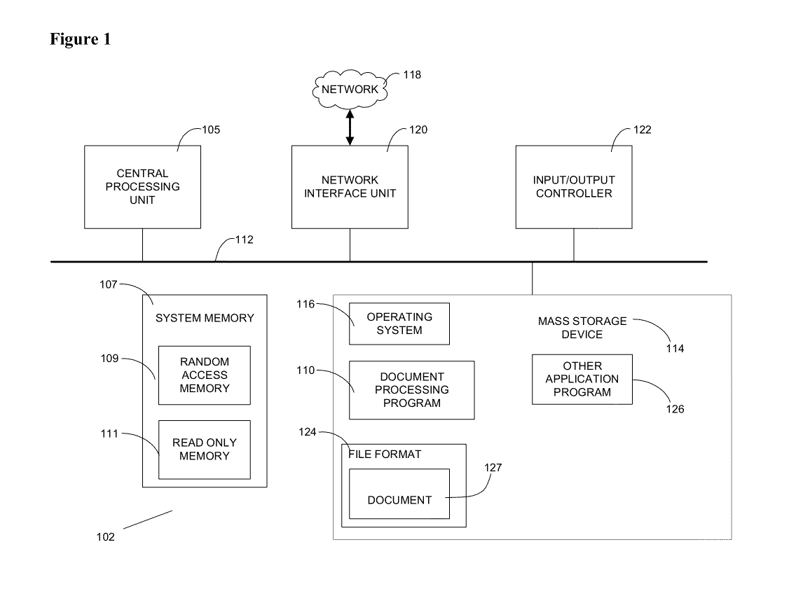

Referring now to the drawings, in which like numerals represent like elements, various aspects of the present invention will be described. In particular, FIG. 1 and the corresponding discussion are intended to provide a brief, general description of an exemplary suitable computing environment in which embodiments of the invention may be implemented. While the invention will be described in the general context of program modules that execute in conjunction with program modules that run on an operating system on a personal computer, those skilled in the art will recognize that the invention may also be implemented in combination with other types of computer systems and program modules.

Generally, program modules include routines, programs, operations, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

FIG. 1 illustrates a computer architecture for a computer 102 utilized in an embodiment of the invention. The computer architecture shown in FIG. 1 illustrates a computing apparatus, such as a server, desktop, laptop, or handheld computing apparatus, including a central processing unit 105 (“CPU”), a system memory 107, including a random access memory 19 (“RAM”) and a read-only memory (“ROM”) 111, and a system bus 112 that couples the memory to the CPU 105. A basic input/output system containing the basic routines that help to transfer information between elements within the computer, such as during startup, is stored in the ROM 111. The computer 102 further includes a mass storage device 114 for storing an operating system 116, application programs, and other program modules, which will be described in greater detail below.

The mass storage device 114 is connected to the CPU 105 through a mass storage controller (not shown) connected to the bus 112. The mass storage device 114 and its associated computer-readable media provide non-volatile storage for the computer 102. Although the description of computer-readable media contained herein refers to a mass storage device, such as a hard disk, flash memory or optical disc drive, it should be appreciated by those skilled in the art that computer-readable media can be any available media that can be accessed by the computer 102.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVJS'), or other optical storage, magnetic cassettes, magnetic tape, magnetic disk storage or other magnetic storage devices, or any other medium which can be used to store the desired information and which can be accessed by the computer 102.

According to various embodiments of the invention, the computer 102 may operate in a networked environment using logical connections to remote computers through a network 118, such as the Internet. The computer 102 may connect to the network 118 through a network interface unit 120 connected to the bus 112. It should be appreciated that the network interface unit 120 may also be utilized to connect to other types of networks and remote computer systems. The computer 102 may also include an input/output controller 122 for receiving and processing input from a number of other devices, including a keyboard, mouse, or electronic stylus (not shown in FIG. 1). Similarly, an input/output controller 122 may provide output to a display screen, a printer, or other type of output device.

As mentioned briefly above, a number of program modules and data files may be stored in the mass storage device 114 and RAM 109 of the computer 102, including an operating system 116 suitable for controlling the operation of a networked personal computer, such as Microsoft WINDOWS, Apple Mac OS, Apple iOS, Google Android, or UNIX. The mass storage device 114 and RAM 109 may also store one or more program modules. In particular, the mass storage device 114 and the RAM 109 may concurrently or at different times store a document processing application program 110. The document processing application program 10 is operative to provide functionality for the viewing, creation and structure of a document as described herein, such as a document 127, in a file format 124 as described further below.

The following description describes an electronic document format utilizing an object framework that allows for the creation of relationships between object data, and a user interface for the viewing and manipulation of documents created in this format.

### Document Structure

The document described herein is not so limited as traditionally understood by conventional “office application” suites. Rather, the document described herein encompasses a much broader concept that allows for the interoperability between different data types within a single application. Furthermore, this document model is not centered around or limited by the final presentation of content as in “office application” suites.

Under this model, a single document type contains all types of content needed by users of “office applications” (i.e. formatted text, spreadsheets, presentations). The documents each comprise a collection of building blocks called “objects.” Each object is a collection of key-value pairs—also referred to as “members” of that object. A key is a non-blank character string created by a user that can be descriptive of the value it is associated with and must be unique within an object. The types of values that are allowed in a key-value pair are shown in Table 1. They are categorized as “atomic” and “composite,” wherein a composite value can have key-value pairs as its members, while an atomic value cannot.

TABLE 1
Data types supported in an object for the value of a key-value pair

| Data Type | | Atomic/ |
|---|---|---|
| Name | Description | Composite |
| Boolean | A value which can either be true or false | Atomic |
| Integer | A value between −9,223,372,036,854,775,808 | Atomic |
| | to 9,223,372,036,854,775,807 | |
| Float | A floating point number in the range ±5.0 × | Atomic |
| | 10⁻³²⁴ to ±1.7 × 10⁺³⁰⁸ | |
| PlainText | A character string | Atomic |
| DateTime | A date-time value which represents date and | Atomic |
| | time. The underlying representation is an | |
| | integer representing the number of | |
| | milliseconds from an arbitrary starting date | |
| Image | An image | Atomic |
| Reference | A character string which is the identifier of | Atomic |
| | another object ,and represents a link to that | |
| | object | |
| Com- | An value which can have key-value pairs as its | Composite |
| position | members, and allows for the layout and styling | |
| | of these key-value pairs (see section 2) | |
| RichText | A value which has text and key-value pairs as | Composite |
| | its members, and where the key-value pairs are | |
| | placed within the flow of text. Individual text | |
| | segments within the text of a RichText item | |
| | can also have styling applied (see section 3) | |
| Chart | A value which represent a chart (see section 5) | Composite |
| DataTable | A value which represent a table (see section 6) | Composite |

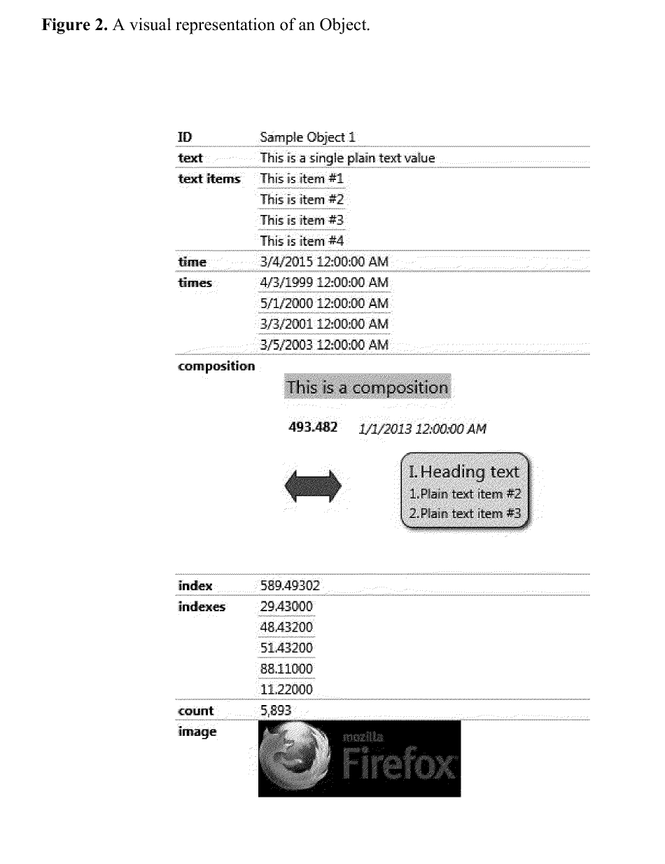

In an object, both a single value and a list of values can be associated with a key. When multiple values are associated with a key, this set of values is referred to as an array. The distinction between a single value and multiple values associated with a key is referred to as the multiplicity of the key-value pair (a single value has multiplicity of “Single”, while an array has multiplicity of “array”). In addition, each object has a PlainText item with the key “ID” whose value serves as the unique identifier of that Object. FIG. 2 illustrates an example of an object.

### Relationships Within a Document

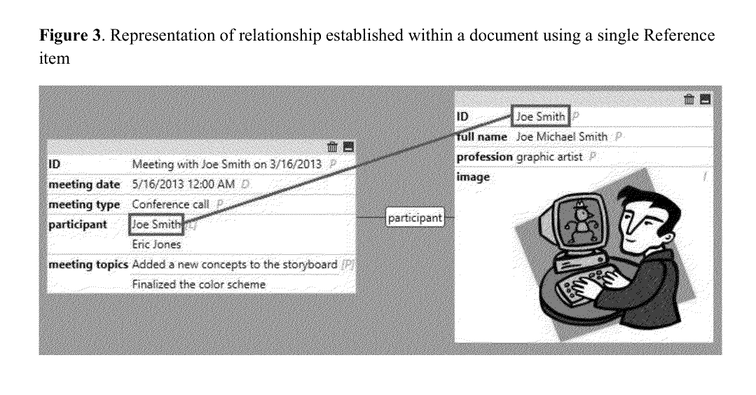

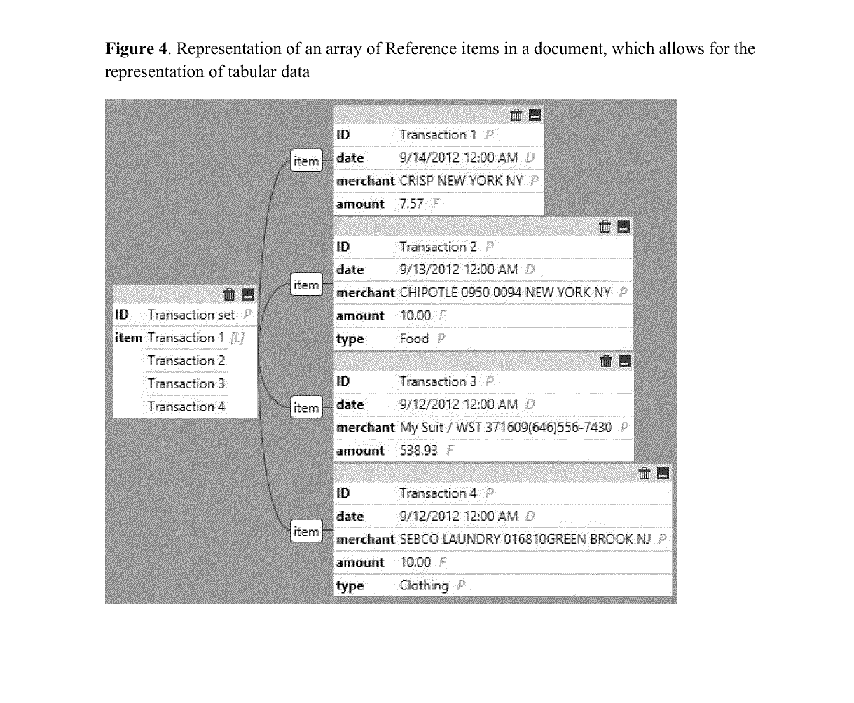

Relationships between objects allow for cross-referencing of a value from a source object in a target object. Relationships are not constrained to a hierarchy and may be created in more than one target object. Relationships can be created through Reference items. The value of a Reference item may be a character string which is equivalent to the ID of another object or other variable representing another object contained in the document. In another embodiment, relationships can be created by reference to an object contained in another document. A Reference item can be single-valued (illustrated in FIG. 3), or an array (illustrated in FIG. 4). If a Reference value is an array, than it groups multiple objects, essentially representing tabular data. The advantage is of this approach is that both tabular and non-tabular data can be worked with in the same application, without having to resort to different data access routines.

### Visual Appearance Settings

A key-value pair in an object may optionally specify the visual appearance of the value. In one embodiment, visual appearances may only be specified for the composite data types (Composition, RichText, Chart and DataTable) and the Image data type.

A Composition is a data type that can be a member of an object as the value of a key-value pair. The Composition data type is a composite data type, which means that it can have key-value pairs as its members. Visually it may be represented as a rectangle within which the visual representations of its key-value pairs are positioned in bounding rectangles whose sizes and placements are computed on the basis of the layout mode of the Composition (see discussion below on LayoutMode style property of a Composition). A Composition may have one or more of the following features:
The visual representation of a Composition can have visual styling applied to it
The values of the key-value pairs in a Composition can have visual styling applied to them
The keys for key-value pairs may be left blank
The Composition supports two additional data types as values in key-value pairs:
   Line: A visual item which shows a line
   Shape: A visual item which shows a shape

The visual styling of the value of a key-value pair within a Composition (and of the Composition itself) is specified by a set of key-value pairs. The key of the styling key-value pair is the name of the styling property, and the value represents an appropriate setting for that styling property.

Some styling properties are available to all data types, while others are only available to specific data types. This is specified in Table 2A-2K.

TABLE 2A
Styling properties applicable to all values of key-value pairs that are members of a
Composition: Positioning Properties

| Property Key | Description | Allowed Values |
|---|---|---|
| CanvasTop | A floating point value that sets the distance of an item from | Any floating point |
| | the top edge of its containing Composition item when that | value |
| | Composition is in canvas layout mode | |
| CanvasLeft | A floating point value that sets the distance of an item from | Any floating point |
| | the left edge of its containing Composition item when that | value |
| | Composition is in Canvas layout mode | |
| GridRow | An integer indicating the row in which an item is placed | An integer of value |
| | when its containing Composition is in Grid layout mode | 1 or greater |
| GridColumn | An integer indicating the column in which an item is | An integer of value |
| | placed when its containing Composition is in Grid layout | 1 or greater |
| | mode | |
| GridRowSpan | An integer indicating the number of rows an item should | An integer of value |
| | occupy when its containing Composition is in Grid layout | 1 or greater |
| | mode | |
| GridColumnSpan | An integer indicating the number of columns an item | An integer of value |
| | should occupy when its containing Composition is in Grid | 1 or greater |
| | layout mode | |
| HorizontalAlignment | An enumerated value that indicates the horizontal | One of the values |
| | positioning of an item relative to the space available to | “Left”, “Center”, |
| | it when its containing Composition is in Stackpanel or | “Right”, “Stretch” |
| | Grid layout mode (see discussion on LayoutMode | |
| | style property of a Composition). It can have the | |
| | following values: | |
| | Left: Item is placed against the left edge of the space | |
| | available to it | |
| | Center: Item is placed so that it is centered | |
| | horizontally in the space available to it | |
| | Right: Item is placed against the right edge of the | |
| | space available to it | |
| | Stretch: Item horizontally occupies all space available | |
| | to it | |
| VerticalAlignment | An enumerated value that indicates the vertical | One of the values |
| | positioning of an item relative to the space available to | “Top”, “Center”, |
| | it when its containing Composition is in Stackpanel or | “Bottom”, “Stretch” |
| | Grid layout mode (see discussion on LayoutMode | |
| | style property of a Composition). It can have the | |
| | following values: | |
| | Top: Item is placed against the top edge of the space | |
| | available to it | |
| | Center: Item is placed so that it is centered vertically | |
| | in the space available to it | |
| | Bottom: Item is placed against the bottom edge of the | |
| | space available to it | |
| | Stretch: Item vertically occupies all space available to | |
| | it | |
| Indent | An integer indicating the amount of space to be placed to | An integer with |
| | left of an item | value of 0 or |
| | | greater |
| Zindex | An integer that sets the stacking order of items that overlap | Any integer value |
| | each other | |

TABLE 2B
Styling properties applicable to all values of key-value pairs that are members of a
Composition: Layout Properties

| Property Key | Description | Allowed Values |
|---|---|---|
| Width | A floating point value setting the width of the element. If | Any value greater |
| | the value is set to NaN (Not a Number), the width of the | than 9.0, and the |
| | element is set to be the minimum value such that the entire | value “NaN” |
| | contents of the items is visible, unless the | corresponding to |
| | HorizontalAlignment of the element is set to Stretch, in | “Not a Number” |
| | which case the horizontal dimension of the element will be | |
| | equivalent to all the horizontal space available to it | |
| Height | A floating point value setting the height of the element. If | Any value greater |
| | the value is set to NaN (Not a Number), the height of the | than 9.0, and the |
| | element is set to be the minimum value such that the entire | value “NaN” |
| | contents of the items is visible, unless the | corresponding to |
| | VerticalAlignment of the element is set to Stretch, in which | “Not a Number” |
| | case the vertical dimension of the element will be | |
| | equivalent to all the vertical space available to it | |
| Margin | A set of 4 floating point numbers indicating the distance | A set of four |
| | from the left, top, right and bottom of the element from the | floating point |
| | space available to it | numbers with |
| | | values of 0.0 or |
| | | greater |
| Padding | A set of 4 floating point numbers indicating the distance | A set of four |
| | from the left, top, right and bottom of the content of the | floating point |
| | element from the bounds of the element | numbers with |
| | | values of 0.0 or |
| | | greater |
| FlippedHorizontal | A boolean value indicating if the horizontal mirror image | True or False |
| | of the visual representation of the element should be | |
| | rendered | |
| FlippedVertical | A boolean value indicating if the vertical mirror image of | True or False |
| | the visual representation of the element should be rendered | |
| Rotation | A floating point value indicating the number of degrees that | Any floating point |
| | the visual representation of the element should be rotated | value |
| | around its center | |

TABLE 2C
Styling properties applicable to all values of key-value pairs that are members of a
Composition: Fill Properties (does not apply to Line, as Line cannot have Fill)

| Property Key | Description | Allowed Values |
|---|---|---|
| FillType | Describes how the bounds of the element's visual | One of the values |
| | representation are to be colored. It can have the | “SolidColor”, |
| | following values: | “LinearGradient”, |
| | SolidColor: The bounds of an element are | “RadialGradient”, |
| | rendered with a single color as the background | “Image”, “Pattern” |
| | (see FillSolidColor property) | |
| | LinearGradient: The bounds of an element are | |
| | rendered with a multi-color gradient as the | |
| | background (see FillGradient, | |
| | LinearGradientAngle properties) | |
| | RadialGradient: The bounds of an element are | |
| | rendered with a multi-color gradient as the | |
| | background (see FillGradient, | |
| | RadialGradientOrigin, RadialGradientX, | |
| | RadialGradientY) | |
| | Image: The bounds of an element are rendered | |
| | with an image as the background (see Filllmage) | |
| | Pattern: The bounds of an element are rendered | |
| | with an pattern as the background which is | |
| | specified with a image and foreground and | |
| | background colors that are used to colorize the | |
| | image | |
| FillSolidColor | A representation of a color value as a hexadecimal | Hexadecimal |
| | value the specifies the A, R, G, and B values of a | specification of the |
| | color. Specifies the color of the background of the | A, R, G and B |
| | visual when FillType is “SolidColor” | values of a color |
| FillGradient | Describes a color gradient. Each stop of the gradient | A string |
| | is represented as the hexadecimal ARGB value of | representation of |
| | the color, a semicolon, and the floating point value | the gradient as |
| | of the stop offset, which ranges from 0 to 1. The | described |
| | gradient is represented by printing the representation | |
| | of each gradient stop followed by a semicolon. | |
| | Applies when FillType is LinearGradient or | |
| | RadialGradient | |
| LinearGradientAngle | A floating point value that describes the rotation of a | Any floating point |
| | linear gradient relative to the bottom edge of an | value |
| | element's visual representation. Applies when | |
| | FillType is LinearGradient | |
| RadialGradientOrigin | A pair of floating point values, representing the | Two floating point |
| | center of a radial gradient as percentages of the | values ranging |
| | width and height of the element. Applies when | from 0.0 to 1.0, |
| | FillType is RadialGradient | separated by a |
| | | comma |
| RadialGradientRadiusX | A floating point value, representing the horizontal | A floating point |
| | dimension of the radial gradient, as percentages of | value ranging from |
| | the width of the element. Applies when FillType is | 0.0 to 1.0 |
| | RadialGradient | |
| RadialGradientRadiusY | A floating point value, representing the vertical | A floating point |
| | dimension of the radial gradient, as percentages of | value ranging from |
| | the height of the element. Applies when FillType is | 0.0 to 1.0 |
| | RadialGradient | |
| FillImage | The image to be used as the fill for the visual | Binary data |
| | representation of the element, represented as binary | representing an |
| | data representing the pixels of an image. Applies | image |
| | when FillType is Image | |
| PatternFillImage | The image to be used as the basis for the fill for the | Binary data |
| | visual representation of the element, represented as | representing an |
| | binary data representing the pixels of an image. The | image |
| | image is colorized using the | |
| | PatternFillForegroundColor and | |
| | PatternFillBackgroundColor style properties. | |
| | Applies when FillType is Image | |
| PatternFillForegroundColor | The foreground color used to colorize an image. | A color, |
| | Applies when FillType is Pattern | represented by a |
| | | hexadecimal value |
| | | specifying the A, |
| | | R, G and B values |
| | | of a color |
| PatternFillBackgroundColor | The background color used to colorize an image. | A color, |
| | Applies when FillType is Pattern | represented by a |
| | | hexadecimal value |
| | | specifying the A, |
| | | R, G and B values |
| | | of a color |

TABLE 2D
Styling properties applicable to all values of key-value pairs that are members of a
Composition: Adorner Properties

| Property Key | Description | Allowed Values |
|---|---|---|
| AdornerType | An enumerated value that describes the type of | One of the values |
| | decorations that are rendered within the bounds of the | “None”, “Border”, |
| | visual representation of the element (Note the Shape | “Shape” |
| | and Line items cannot have this a style property) | |
| ShapeType | Applies when AdornerType is Shape (Note the Line | A text value |
| | items cannot have this a style property) | describing the type |
| | | of shape (e.g. |
| | | Rectangle, Circle, |
| | | etc.) |
| LineColor | Specifies the color used to render the outline of a shape. | A color, |
| | Applies when AdornerType is Shape | represented by a |
| | | hexadecimal value |
| | | specifying the A, |
| | | R, G and B values |
| | | of a color |
| LineThickness | Specifies the thickness of the line used to render the | A floating point |
| | outline of a shape. Applies when AdornerType is Shape | value ranging from |
| | | 0.0 to 9.0 |
| LineDashStyle | Specifies the dash style of the line used to render the | One of the values |
| | outline of a shape. Applies when AdornerType is Shape | “Solid”, |
| | | “LongDash”, |
| | | “ShortDash” |
| BorderLeftColor, | The color used to render the respective border edge. | A color, |
| BorderRightColor, | Applies when AdornerType is Border | represented by a |
| BorderTopColor, | | hexadecimal value |
| BorderBottomColor | | specifying the A, |
| | | R, G and B values |
| | | of a color |
| BorderLeftDashStyle, | The dash style used to render the respective border | One of the values |
| BorderTopDashStyle, | edge. Applies when AdornerType is Border | “Solid”, |
| BorderBottomDashStyle, | | “LongDash”, |
| BorderRightDashStyle | | “ShortDash” |
| BorderLeftThickness, | Specifies the thickness of the line used to render the | A floating point |
| BorderRightThickness, | respective border edge. Applies when AdornerType is | value ranging from |
| BroderBottomThickness, | Border | 0.0 to 9.0 |
| BorderTopThickness | | |

TABLE 2E
Styling properties applicable to all values of key-value pairs that are members of a
Composition: Edge Effect Properties

| Property Key | Description | Allowed Values |
|---|---|---|
| EdgeEffect | Specifies the effect rendered around the edge of the visual | One of the values |
| | representation of an element. It can have the following | “None”, “Shadow”, |
| | values: | “Glow” |
| | None: The element is rendered without an edge effect | |
| | Shadow: A simulation of a shadow is rendered about | |
| | the edge of the element | |
| | Glow : A simulation of glow is rendered about the edge | |
| | of the element | |
| ShadowColor | The color used to render a shadow effect. Applies when | A color, |
| | EdgeEffect is Shadow | represented by a |
| | | hexadecimal value |
| | | specifying the A, R, |
| | | G and B values of a |
| | | color |
| ShadowDepth | The depth used to render a shadow effect. Applies when | A floating point |
| | EdgeEffect is Shadow | value of 0.0 or |
| | | greater |
| ShadowDirection | A value that specifies the direction of a shadow effect. | Any floating point |
| | Applies when EdgeEffect is Shadow | value |
| ShadowOpacity | The opacity of a shadow effect, where 0.0 is transparent | A floating point |
| | and 1.0 is opaque. Applies when EdgeEffect is Shadow | value from 0.0 to |
| | | 1.0 |
| ShadowBlurRadius | The blur radius used to render a shadow effect. Applies | A floating point |
| | when EdgeEffect is Shadow | value of 0 or |
| | | greater |
| GlowColor | A color used to render a glow effect. Applies when | A color, |
| | EdgeEffect is Glow | represented by a |
| | | hexadecimal value |
| | | specifying the A, R, |
| | | G and B values of a |
| | | color |
| GlowRadius | The blur radius used to render a glow effect. Applies when | A floating point |
| | EdgeEffect is Glow | value of 0.0 or |
| | | greater |

TABLE 2F
Styling properties applicable to textual data types (Boolean, Float, Integer, DateTime,
PlainText, Reference and RichText)

| Property Key | Description | Allowed Values |
|---|---|---|
| FontFamily | Specifies the font family for rendering text | A character string |
| | | representing a font |
| | | family |
| FontSize | Specifies the size of the characters for rendering text | An integer of value |
| | | 0 or greater |
| FontColor | Specifies the color for rendering text | A color, |
| | | represented by a |
| | | hexadecimal value |
| | | specifying the A, |
| | | R, G and B values |
| | | of a color |
| IsBold | Specifies if text is to be rendered as bold text | True or false |
| IsItalic | Specifies if text is to be rendered as italic text | True or false |
| IsOverline | Specifies if text is to be rendered with an overline | True or false |
| | decoration | |
| IsStrikethrough | Specifies if text is to be rendered with a strikethrough | True or false |
| | decoration | |
| IsUnderline | Specifies if text is to be rendered with an underline | True or false |
| | decoration | |
| LineSpacing | Specifies the spacing between successive lines of text | A floating point |
| | | number of value |
| | | 0.0 or greater |
| HorizontalTextAlignment | Specifies how text is to be rendered. Can have one of | Values of “Left”, |
| | four values: | “Center”, “Right”, |
| | Left: Text is left aligned | “Justified” |
| | Right: Text is right aligned | |
| | Center: Text is center aligned | |
| | Justified: Text is justified | |
| VerticalTextAlignment | Specifies the vertical alignment of the rendering of a | Values of “Top”, |
| | text value relative to the rectangle available to it. Can | “Center”, “Bottom” |
| | have one of three values | |
| | Top: Text is aligned to the top of the available | |
| | space | |
| | Center: Text is vertically centered | |
| | Bottom: Text is aligned to the bottom of the | |
| | available space | |
| MarkerStyle | Specifies the appearance of the marker placed to the | Values of: |
| | left of a text item. Can have one of 16 values: | “UpperRoman”, |
| | UpperRoman | “UpperLatin”, |
| | UpperLatin | “LowerRoman”, |
| | LowerRoman | “LowerLatin”, |
| | LowerLatin | “Decimal”, |
| | Decimal | “DecimalLevel2”, |
| | DecimalLevel2: Two level decimal (e.g. 1.1) | “DecimalLevel3”, |
| | DecimalLevel3: Three level decimal (e.g. 1.1.1) | “DecimalLevel4”, |
| | DecimalLevel4: Four level decimal (e.g. 1.1.1.1) | “DecimalLevel5”, |
| | DecimalLevel5: Five level decimal (e.g. 1.1.1.1.1) | “DecimalLevel6”, |
| | DecimalLevel6: Six level decimal (e.g. | “DecimalLevel7”, |
| | 1.1.1.1.1.1) | “Disc”, |
| | DecimalLevel7: Seven level decimal (e.g. | “Circle”, |
| | 1.1.1.1.1.1.1) | “Box”, |
| | Disc | “Square”, |
| | Circle | “None” |
| | Box | |
| | Square | |
| | None | |
| MarkerColor | Specifies the color the marker if MarkerStyle is not set | A color, |
| | to “None” and MarkerColorMode is set to “Specified” | represented by a |
| | | hexadecimal value |
| | | specifying the A, |
| | | R, G and B values |
| | | of a color |
| MarkerColorMode | Specifies how the color of the marker will be | Value of |
| | determined Can have two values: | “MatchFont” or |
| | MatchFont: the marker's color will the same as the | “Specified” |
| | color of the text font | |
| | Specified: The color value of MarkerColor is used | |

TABLE 2F
Styling properties applicable to the Float data type

| Property Key | Description | Allowed Values |
|---|---|---|
| FloatFormat | Specifies the format string for rendering | A floating point |
| | floating point values. Allows the user to | format string |
| | specify the number of digits to the left or | |
| | right of the decimal point and | |
| | scientific notation | |

TABLE 2G
Styling properties applicable to Integer data type

| Property Key | Description | Allowed Values |
|---|---|---|
| IntegerFormat | Specifies the format string for rendering | An integer |
| | integer values. Allows the user to specify | format string |
| | the number of digits to the left of the | |
| | decimal point and presence of comma | |
| | separator | |

TABLE 2H
Styling properties applicable to the DateTime data type

| Property Key | Description | Allowed Values |
|---|---|---|
| DateTimeFormat | Specifies the format string for | A date time |
| | rendering date time values. | format string |

TABLE 2I
Styling properties applicable to the Line data type

| Property Key | Description | Allowed Values |
|---|---|---|
| LineType | Specifies the type of line | Values of: |
| | to be rendered | “StraightLine”, |
| | | “ArcLine”, |
| | | “StraightElbow”, |
| | | “CurvedElbow” |
| LineAnchorPoint | Specifies where the start point | Values of: |
| | of the line will be placed | “TopLeft”, |
| | | “TopRight”, |
| | | “BottomLeft”, |
| | | “BottomRight” |
| StartArrowheadStyle | Specifies the decoration | Values of: |
| | rendered at the start of the line | “None”, |
| | | “OpenArrow”, |
| | | “ClosedArrow”, |
| | | “Diamond”, |
| | | “Disc” |
| EndArrowheadStyle | Specifies the decoration | Values of: |
| | rendered at the end of the line | “None”, |
| | | “OpenArrow”, |
| | | “ClosedArrow”, |
| | | “Diamond”, |
| | | “Disc” |
| ArcSweepDirection | Specifies sweep direction for | Values of |
| | drawing a line | “Clockwise”, |
| | | “CounterClockwise” |

TABLE 2J
Styling properties applicable to Image data type

| Property Key | Description | Allowed Values |
|---|---|---|
| ImageStretchMode | Specifies how an image is to be | Values of “None”, |
| | rendered relative to the | “Fill”, “Uniform”, |
| | space available to it | “UniformToFill” |

TABLE 2K
Styling properties applicable to Composition data type

| Property Key | Description | Allowed Values |
|---|---|---|
| PanelLayoutMode | Specifies how the visuals of the values of the | Values of “Canvas”, |
| | members of the Composition are to be arranged | “Grid”, |
| | relative. One of four values: | “StackPanel”, |
| | Canvas: Positioning of a visual is based on the | “WrapPanel” |
| | values of its CanvasLeft and CanvasTop style | |
| | properties | |
| | Grid: The area of the Composition is divided | |
| | into a grid pattern, with the positioning of a | |
| | visual based on the values of its GridRow, | |
| | GridColumn, GridRowSpan, GridColumnSpan | |
| | style properties | |
| | StackPanel: By default, visuals are positioned | |
| | sequentially, from top to bottom of the | |
| | Composition. Visuals may also positioned from | |
| | bottom to top, left to right or right to left as | |
| | specified by the StackPanelMode property. | |
| | WrapPanel: By default, visuals are positioned | |
| | sequentially, from left to right, and continuing at | |
| | the next line below and at the left edge when | |
| | content has reached the right edge of the | |
| | Composition. Visuals may also flow from the | |
| | top left corner down, and continuing at the next | |
| | column when content has reached the bottom of | |
| | the composition. This is specified by the | |
| | WrapPanelMode property. | |
| GridRowCount | Specifies the number of rows when a Composition is | An integer of value |
| | in Grid layout mode | of 1 or greater |
| GridColumnCount | Specifies the number of columns when a | An integer of value |
| | Composition is in Grid layout mode | of 1 or greater |
| GridRowMode | Specifies how rows are to be sized when a | Values of “Auto”, |
| | Composition is in Grid layout mode. One of three | “Equal”, “Specified” |
| | values | |
| | Auto: Each row sizes automatically based on | |
| | visuals placed or overlapping that row | |
| | Equal: All rows have the same size | |
| | Specified: the dimensions of the rows are | |
| | determined by GridRowSpecifications | |
| GridColumnMode | Specifies how columns are to be sized when a | Values of “Auto”, |
| | Composition is in Grid layout mode. One of three | “Equal”, “Specified” |
| | values | |
| | Auto: Each column sizes automatically based on | |
| | visuals placed or overlapping that column | |
| | Equal: All columns have the same size | |
| | Specified: the dimensions of the columns are | |
| | determined by GridColumnSpecifications | |
| GridRowSpecifications | A string of comma separated values indicating how | A string |
| | rows are to be sized when GridRowMode is set to | representation of the |
| | Specified. Each value can be one of: | specification of row |
| | “A”: indicates that the row is to be sized | heights as described |
| | automatically | |
| | “P”: indicates that the height of the row is to be | |
| | the same as all rows that are specified as “P” | |
| | A floating point number: specifies a fixed height | |
| | for a row | |
| | A sample GridRowSpecifications value would | |
| | look like this: “A, P, 20.0, 20.0, P, A” | |
| GridColumnSpecifications | A string of comma separated values indicating how | A string |
| | columns are to be sized when GridColumnMode is | representation of the |
| | set to Specified. Each value can be one of: | specification of |
| | “A”: indicates that the column is to be sized | column widths as |
| | automatically | described |
| | “P”: indicates that the height of the column is to | |
| | be the same as all columns that are specified as “P” | |
| | A floating point number: specifies a fixed width | |
| | for a row | |
| StackPanelMode | Indicates how items are to be arranged when a | One of the values |
| | Composition is in StackPanel layout mode. Can have | “TopToBottom”, |
| | one of four values: | “BottomToTop”, |
| | TopToBottom | “LeftToRight”, |
| | BottomToTop | “RightToLeft” |
| | LeftToRight | |
| | RightToLeft | |
| WrapPanelMode | Indicates how items are to be arranged when a | One of the values |
| | Composition is in WrapPanel layout mode. Can have | “TopLeftToRight”, |
| | one of two values: | “TopLeftToBottom”, |
| | TopLeftToRight | |
| | TopLeftToBottom | |
| ItemsKeyVisible | Indicates if the keys of the values of the members of | True or false |
| | the compositions should be visible | |
| ItemsExpressionVisible | Indicates if the expressions (see section 4) of the | True or false |
| | values of the members of the compositions should be | |
| | visible | |

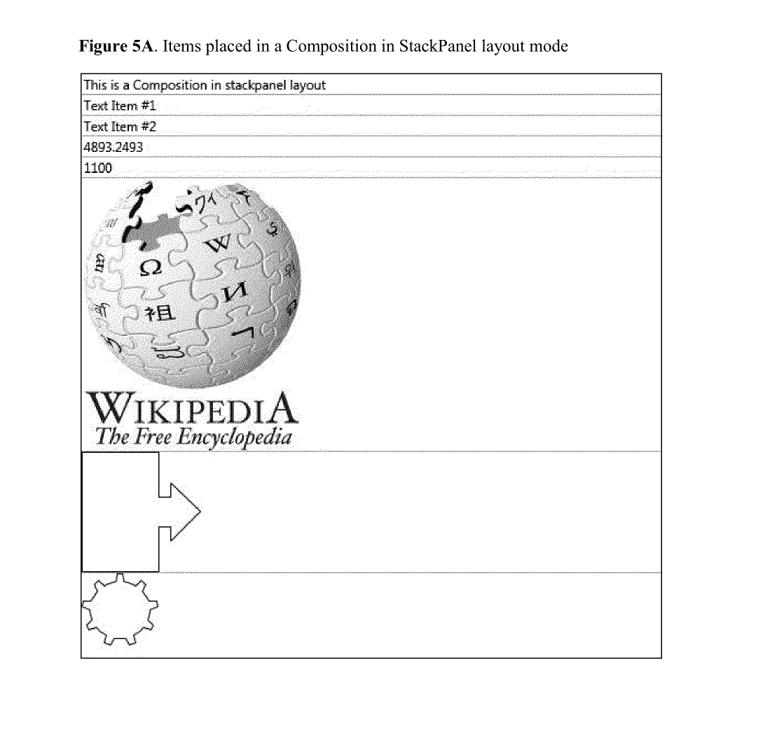

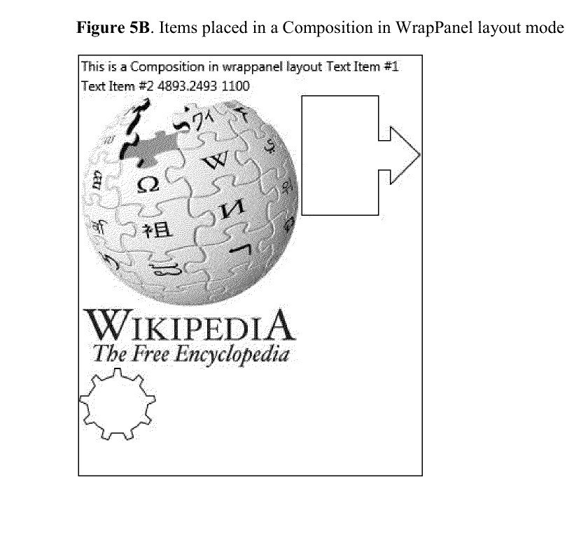

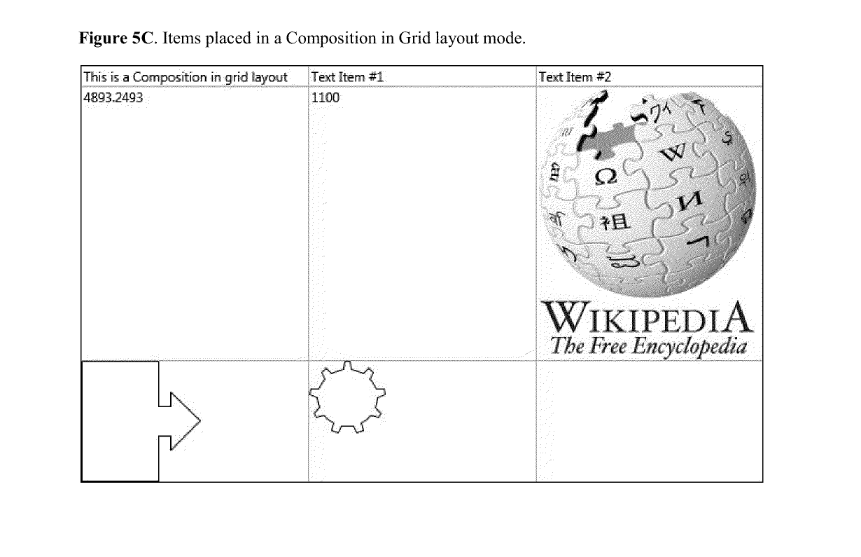

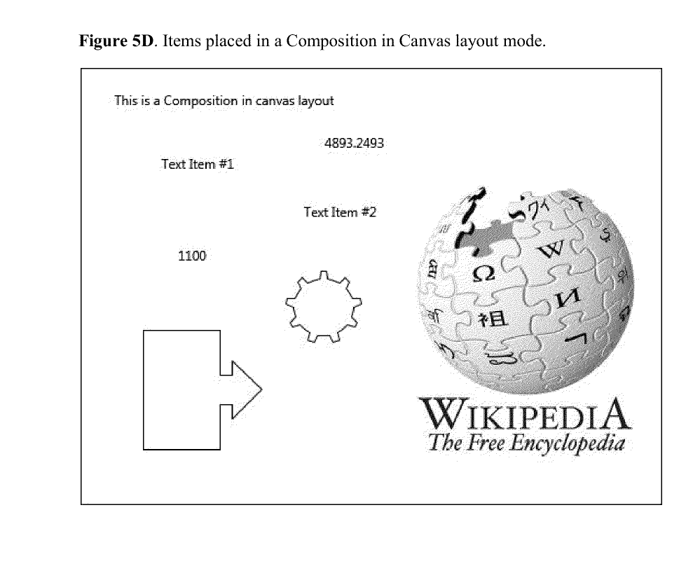

A Composition can support different layout modes which determine how the visual representations of the values of its members are placed (the PanelLayoutMode property). The layout modes that can be specified for a Composition are
(a) StackPanel (see FIG. 5A), in which items are laid out in a linear manner
(b) WrapPanel (see FIG. 5B), in which items are laid out in a wrapping manner
(c) Grid (see FIG. 5C), in which items are laid out using grid coordinates (properties GridRow, GridColumn, GridRowSpan, GridColumnSpan)
(d) Canvas (FIG. 5D), in which items are laid out using X-Y coordinates (properties CanvasLeft and CanvasTop)

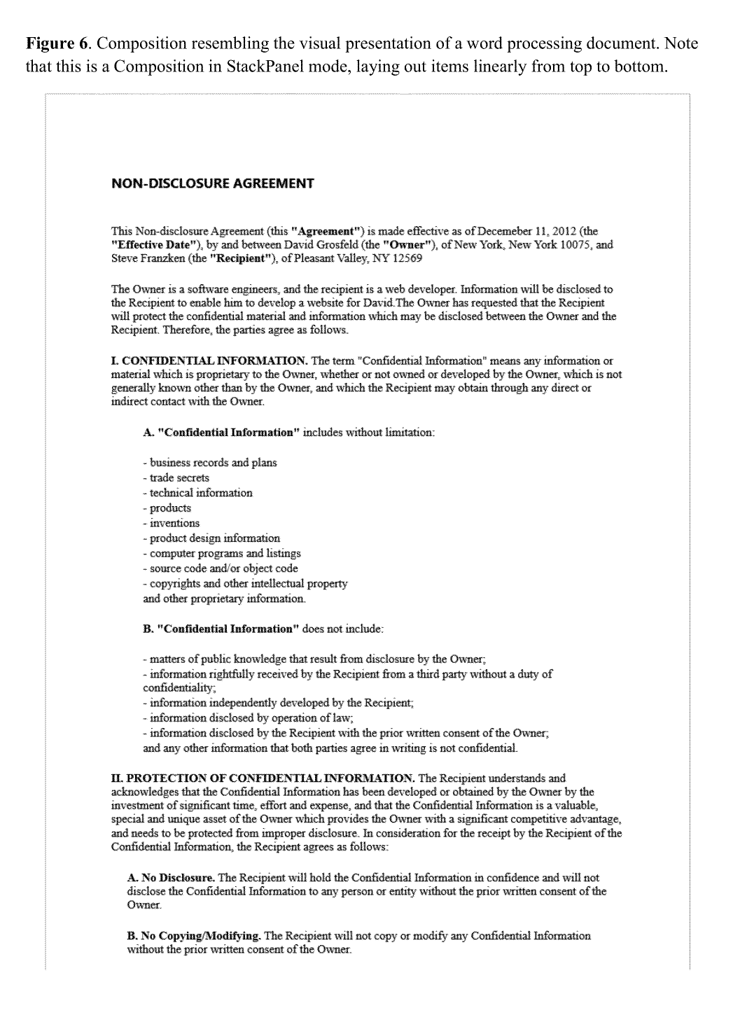

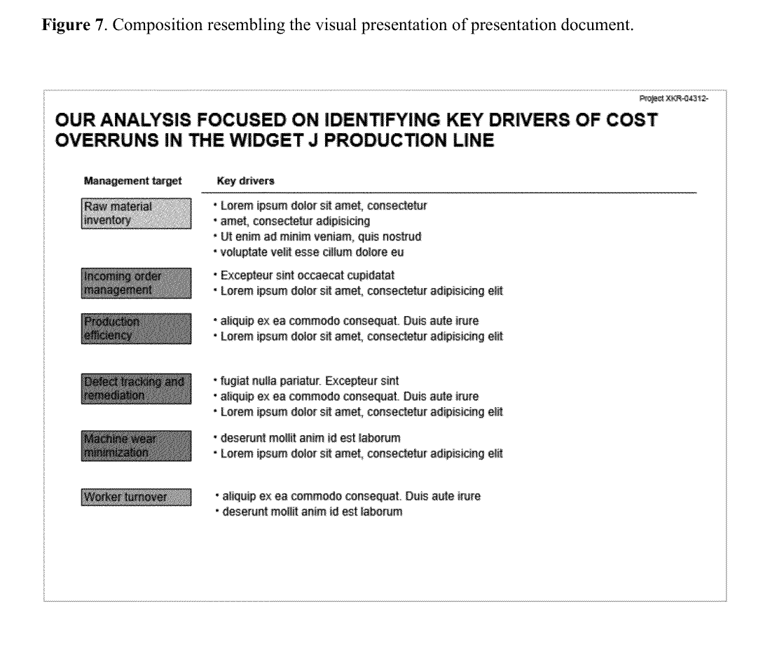

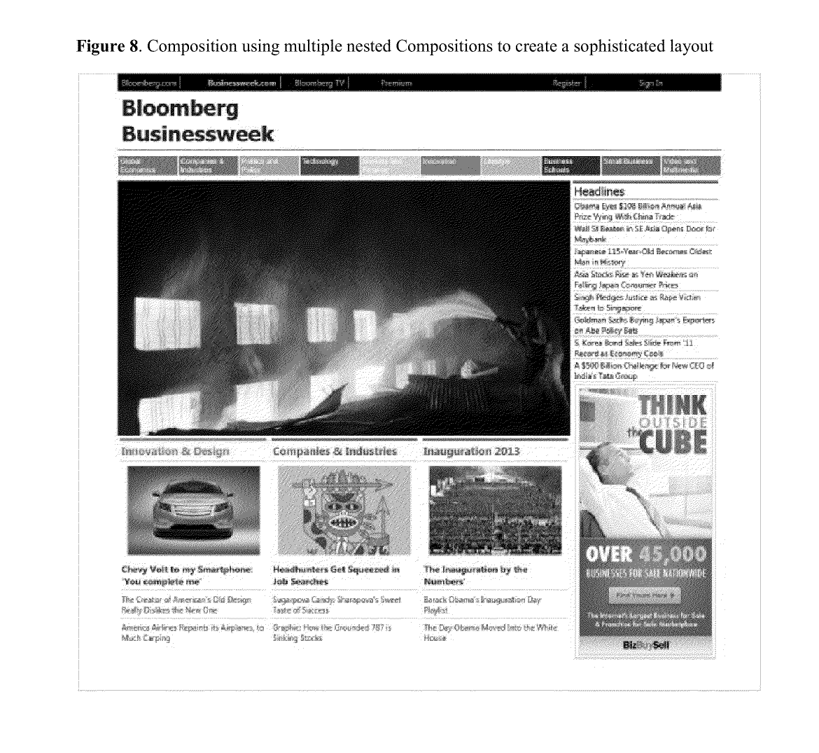

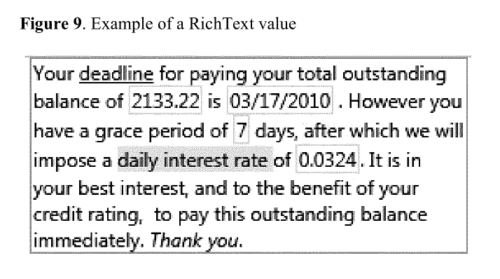

By altering the layout mode of a Composition, placing Compositions within each other and setting the style properties of elements, visual presentations can be created that resemble those created by traditional word processing programs (see FIG. 6), presentation programs (see FIG. 7), and HTML used for websites (see FIG. 8). FIG. 6 illustrates an example of a Composition in StackPanel mode and provides a visual representation similar to a traditional word processing document as known in the prior art, laying out items linearly from top to bottom. FIG. 7 illustrate a Composition in canvas mode and provides a visual representation similar to a traditional presentation document as known in the prior art. The bulleted text items are actually contained within Compositions that are contained in the top level Composition. FIG. 8 illustrates a Composition using multiple nested Compositions to create a sophisticated layout that provides a visual representation similar to that of HTML encoded websites. This hybrid approach allows a user to create different types of visual presentations traditionally associated with different applications in a single application, and store them in a single format. The RichText value allows a user to do the following: have differently styled runs of text, and place key-value pairs within in the flow of text. Thus a RichText value may have key-value pairs as members (and is a composite value). An example of a rich text item is illustrated in FIG. 9. The boxed items are key-value pairs that that are members of the RichText value and are embedded in the flow of text. The values of the embedded key-value pairs may be styled in the manner described in the section on Compositions (see Tables 2A-2K).

### Complex Data Content

Expressions allow for the value of a key-value pair to be the result of a computational expression. Any key-value pair, whether contained within an object, Composition or RichText can have its value set to be the result of an expression. This allows a user to place computations anywhere within the document, including having them embedded in visual content or in the flow of text.

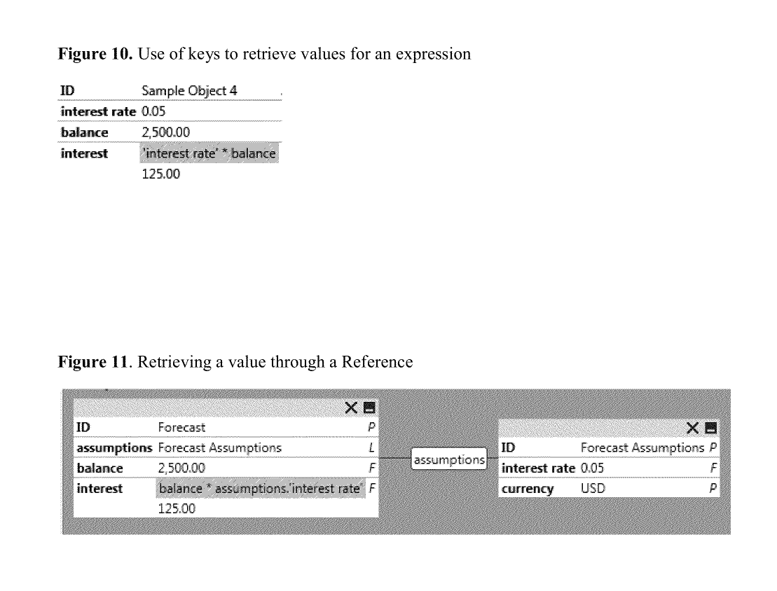

Values to be used as arguments in expressions may be specified: as “literals” (i.e. numbers, strings, dates, etc.) or by specifying a key in an object, which is used to retrieve the value of a key-value pair in that object. Obtaining a value in this manner is called dereferencing. A basic use of dereferencing is shown in FIG. 10.

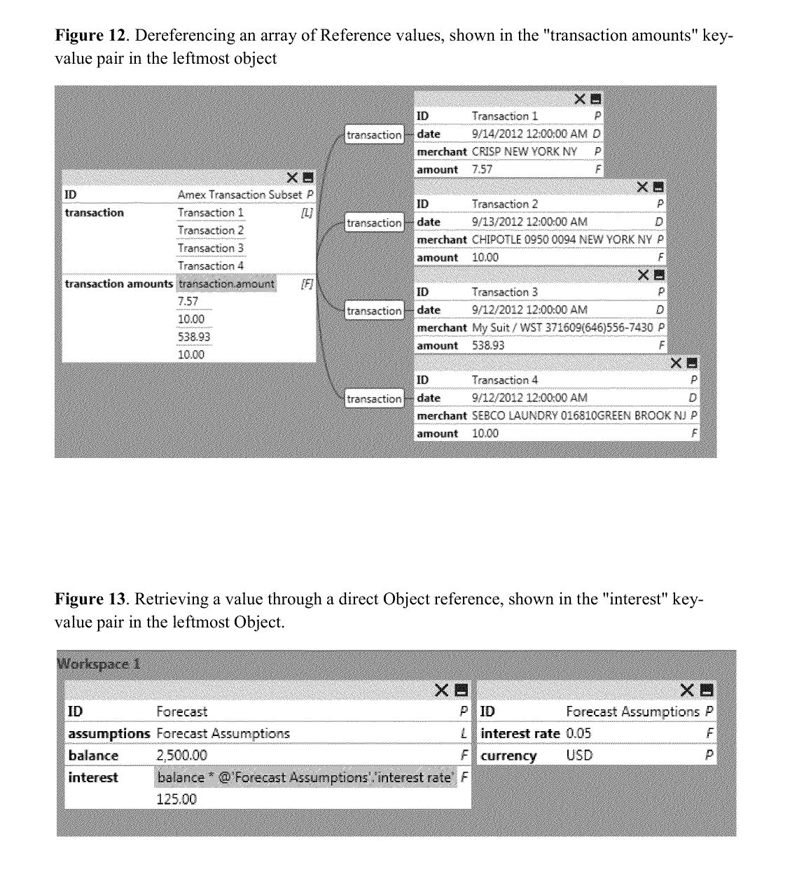

If a value is of the Reference type, values from the objects it refers to can be retrieved by placing a dot (“.”) following the key of the Reference value, followed by the key in object referred to by the Reference value (see FIG. 11). For example, in FIG. 11, the expression “assumptions. ‘interest rate’” first specifies the ID “Forecast Assumptions” from the key-value pair with the key “assumptions”. It then specifies the value associated with key “interest rate” in the object with ID “Forecast Assumptions”. If the Reference value is an array, the value is retrieved from each Object that is referred to (see FIG. 12). FIG. 12 illustrates dereferencing an array of Reference values, shown in the “transaction amounts” key-value pair in the leftmost object

A value can also be retrieved using a direct Object reference, where the “@” sign is followed by the ID value of the Object, followed by a dot (“.”), followed by the key of the value to be retrieved (see FIG. 13). FIG. 13 illustrates how a value is retrieved through a direct Object reference, shown in the “interest” key-value pair in the leftmost Object. The expression @‘Forecast Assumptions’.‘interest rate’ retrieves the value associated with key “interest rate” in object with ID “Forecast Assumptions”.

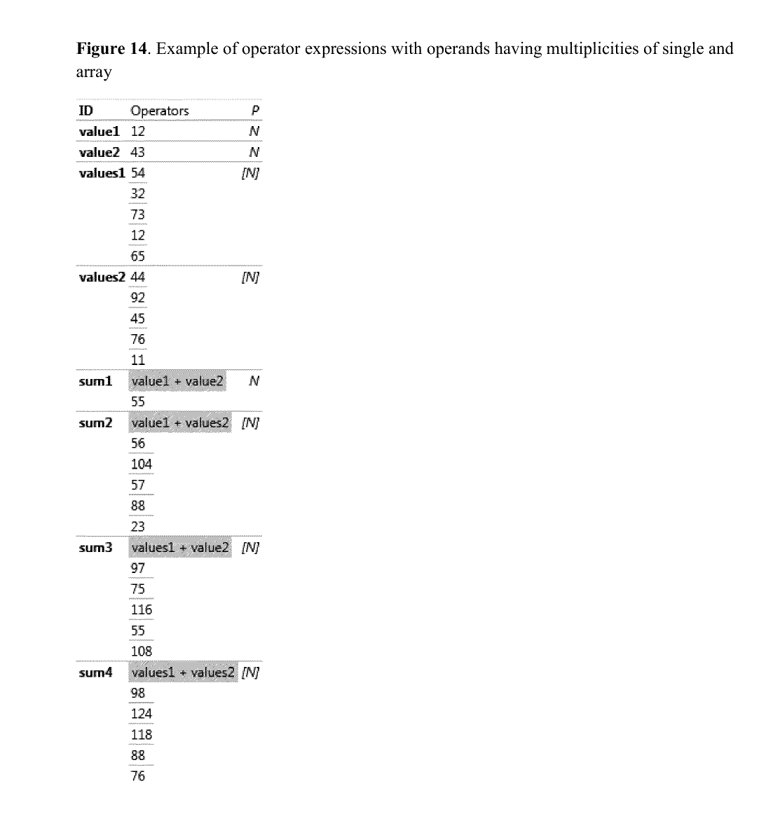

Binary operator expressions can take both arrays and single values as arguments. The rules for handling arrays and single values are shown in Table 3 (an example is illustrated in FIG. 14).

TABLE 3
Rules for handling operand multiplicities in binary operator expressions

| Left Operand | Right Operand | Treatment |
|---|---|---|
| Single | Single | Perform the operation with the left and right operands, |
| | | returning a single value |
| Single | Array | Repeat the operation with the left operand and every single item |
| | | in the right operand, returning an array of values |
| Array | Single | Repeat the operation with the right operand and every single |
| | | item in the left operand, returning an array of values |
| Array | Array | Left and right operands must have the same number of values. |
| | | Perform the operation pair wise with items with corresponding |
| | | indices from the left and right operands, returning and array of |
| | | values |

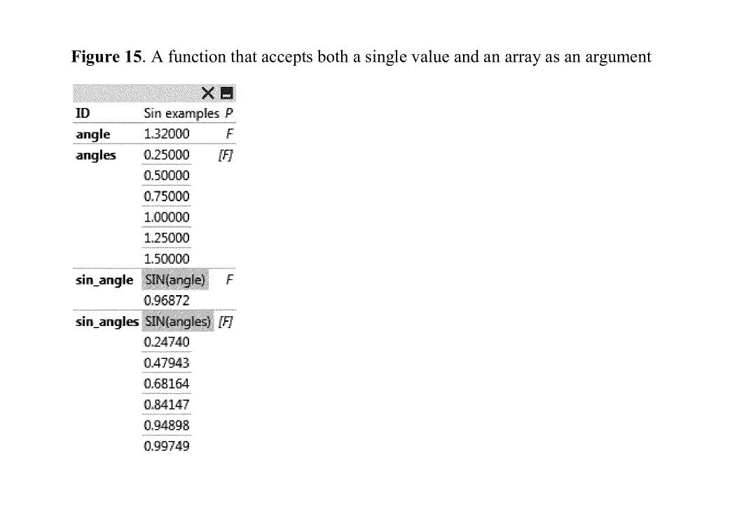

Functions may exhibit a similar level of flexibility with respect to multiplicities of their arguments. Some functions which normally accept a single argument (e.g. SIN(X)) can also accept an array argument. When an array is passed to such a function, the function is repeated over each member of the array (see FIG. 15).

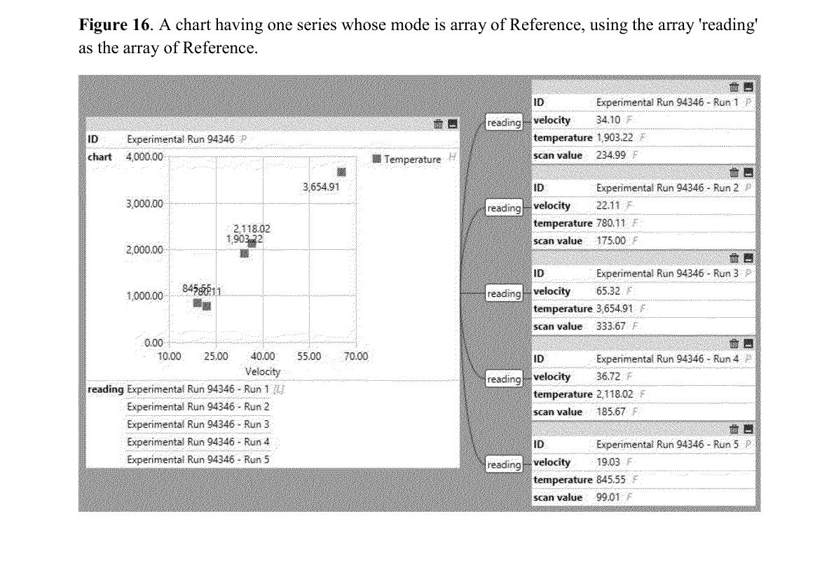

A Chart is a data type characterized by the graphical representation of one or more series of tuples of values. To specify the values to be used in rendering a series, two modes are possible: using an array of Reference values, and using discrete arrays of values. When using an array of Reference values, an expression is provided which must evaluate to an array of Reference values. The dependent and independent values are specified as keys, as described in FIG. 16. In FIG. 16, a chart is displayed with one series whose mode is an array of Reference values, and uses the array ‘reading’ as the array of Reference. The horizontal axis value is specified as “velocity”, and the vertical axis value is specified as “temperature”. The value associated with key “velocity” is retrieved from each referred object and used as the independent value for each series point, and the value associated with the key “temperature” is retrieved from each object and used as the dependent value for each series point.

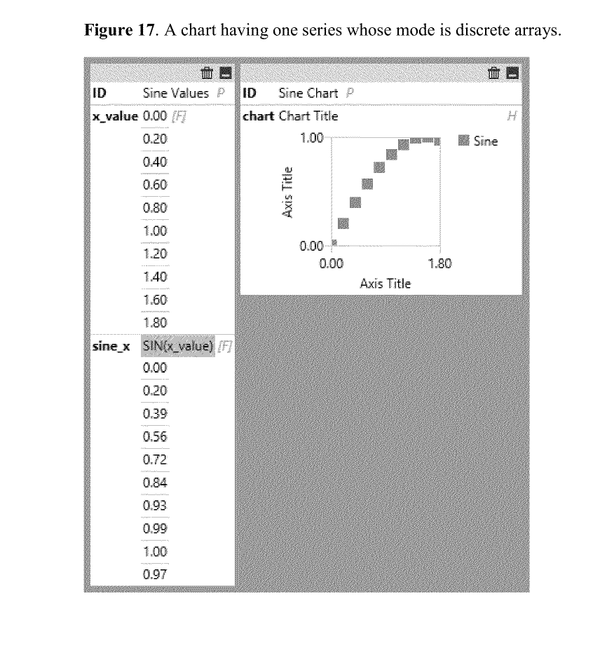

When using discrete arrays of values, two expressions are provided, each of which must evaluate to an array of values, and both arrays must have the same number of items. For example, in FIG. 17, a chart is shown with one series whose mode is discrete arrays. The independent value is specified as “@‘Sine Values’.x_value” and the dependent value is specified as “@‘Sin Values’.sine_x”.

One or more of the following components of a Chart can be styled as described above:

Chart

Title

Legend

Plot Area

Axis

Axis Title

Axis Label

Series

Series Label

The style properties applicable to a chart are as follows:

All Positioning Properties (Table 2A)

All Layout Properties (Table 2B)

All Fill Properties (Table 2C)

All Adorner Properties (Table 2D)

All Edge Effect Properties (Table 2E)

Chart specific style properties (Table 4)

TABLE 4
Style properties applicable to a Chart

| Property Key | Description | Allowed Values |
|---|---|---|
| LegendVisible | Specifies visibility of the chart legend | True/False |
| ChartTitleVisible | Specifies visibility of the chart title | True/False |
| ChartTitlePlacement | Specifies the placement of the chart title | One of “Top”, “Bottom” |
| HorizontalAxisVisible | Specifies visibility of the horizontal chart axis | True/False |
| VerticalAxisVisible | Specifies visibility of the vertical chart axis | True/False |

The style properties applicable to a chart title are as follows

All Layout Properties (Table 2B)

All Fill Properties (Table 2C)

All Adorner Properties (Table 2D)

All Edge Effect Properties (Table 2E)

Selected Text properties (Table 2F)

The style properties applicable to a chart legend are as follows

Selected Layout Properties (Table 2A)

All Fill Properties (Table 2C)

All Adorner Properties (Table 2D)

All Edge Effect Properties (Table 2E)

Selected Text properties (Table 2F)

The style properties applicable to a plot area are as follows

All Fill Properties (Table 2C)

Plot area specific style properties (Table 5)

TABLE 5
Style properties applicable to a plot area

| Property Key | Description | Allowed Values |
|---|---|---|
| BorderColor | Specifies the color of | A color, |
| | the plot area border | represented by a |
| | | hexadecimal value |
| | | specifying the A, |
| | | R, G and B values |
| | | of a color |
| NominalGridlineAlignment | Specifies visibility of | One of |
| | the chart title | “BetweenValues”, |
| | | “CenterOnValues” |

The style properties applicable to a plot area are as follows

Axis specific style properties (Table 6)

TABLE 6
Style properties applicable to a chart axis

| Property Key | Description | Allowed Values |
|---|---|---|
| MinMaxMode | Specifies if the endpoint values of the axis are | One of “Manual”, |
| | determined automatically or set by the user | “Automatic” |
| FloatMinimum | The minimum axis value when MinMaxMode is set | A floating point |
| | to Manual | value |
| FloatMaximum | The maximum axis value when MinMaxMode is set | A floating point |
| | to Manual | value |
| IntervalCount | Specifies the number of intervals in the axis | An integer |
| TickMarksColor | Specifies the color of axis tickmarks | A color, |
| | | represented by a |
| | | hexadecimal value |
| | | specifying the A, |
| | | R, G and B values |
| | | of a color |
| TickMarksVisible | Specifies the visibility of axis tickmarks | True/False |
| AxisTitleVisible | Specifies the visibility of axis title | True/False |
| AxisLabelsVisible | Specifies the visibility of axis value labels | True/False |

The style properties applicable to an axis title are as follows

Selected Layout Properties (Table 2A)

All Fill Properties (Table 2C)

Selected Text properties (Table 2F)

The style properties applicable to a chart series are as follows

Style properties applicable to a chart series (Table 7)

TABLE 7
Style properties applicable to a chart series

| Property Key | Description | Allowed Values |
|---|---|---|
| LineChartThickness | Specifies the thickness of a chart series that is a line | An integer value |
| | series | from 1-9 |
| MarkerVisible | Specifies the visibility of chart markers | True/False |
| MarkerSize | Specifies the size of chart markers | An integer value |
| SeriesMarkerType | Specifies the marker shape | A text value |
| | | describing a shape, |
| | | such as “Square”, |
| | | “Circle”, etc. |
| SeriesLabelVisible | Specifies the visibility of series labels | True/False |

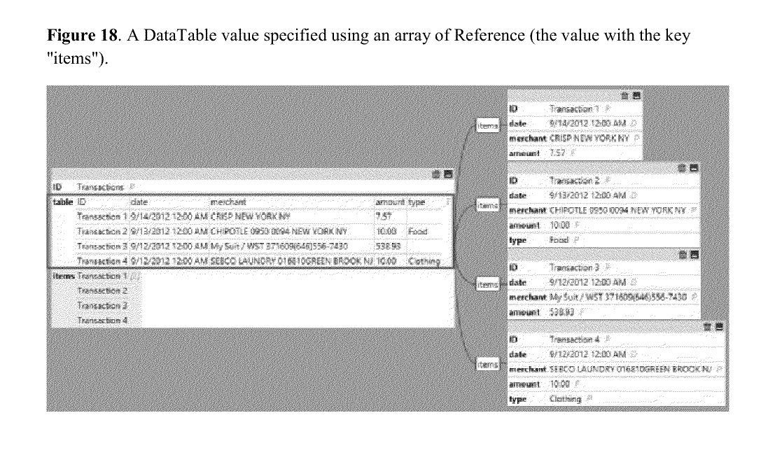

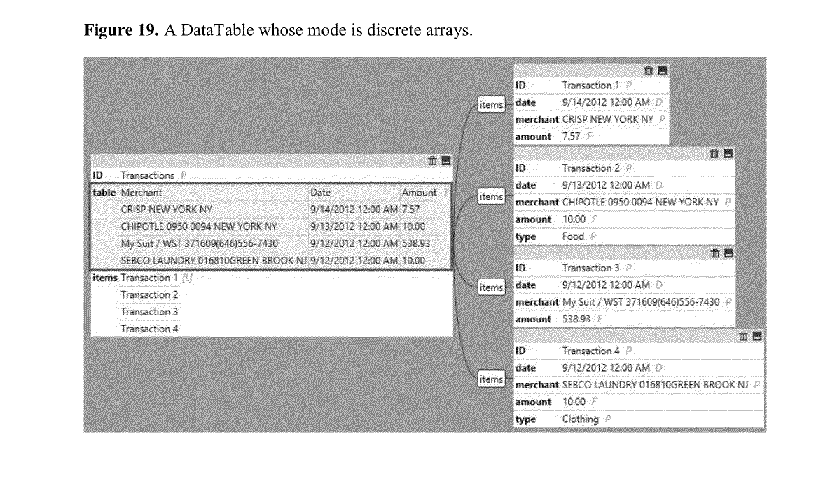

A DataTable is a data type characterized by a graphical, tabular display of values. Similar to the Chart, values used to populate the DataTable can be specified using an array of Reference values (as illustrated in FIG. 18) or discrete arrays of values (as illustrated in FIG. 19). In FIG. 18, a DataTable value specified using an array of Reference (the value with the key “items”) is illustrated. In this embodiment, no other specification is needed, as any key that appears in any of the referred objects becomes a column header. In FIG. 19, a DataTable whose mode is discrete arrays is shown. The first column is specified as “items.merchant” the second column is specified as “items.date” and the third column as “items.amount”. In this embodiment, the headers of the columns are arbitrary and selected by the user.

Each of the following components of the DataTable can be styled:

Entire DataTable
All Positioning Properties (Table 2A)
All Layout Properties (Table 2B)
All Fill Properties (Table 2C)
All Adorner Properties (Table 2D)
All Edge Effect Properties (Table 2E)

Table Header
Selected Layout Properties (Table 2B)
All Fill Properties (Table 2C)
All Adorner Properties (Table 2D)
All Edge Effect Properties (Table 2E)
Selected Text properties (Table 2F)

Table item
Style properties that are applicable to the data type of the column
Setting a style property of any item in a column causes that style property to be set on all items in the column

### User Interface for Viewing and Editing Documents

According to yet another aspect of the invention, a system for displaying and modifying electronic documents comprises an electronic document file, an editor, and an encoder. The editor is arranged to prompt and receive custom properties for the document from a user. The encoder is arranged to encode the document in the text format described in the last aspect of this invention.

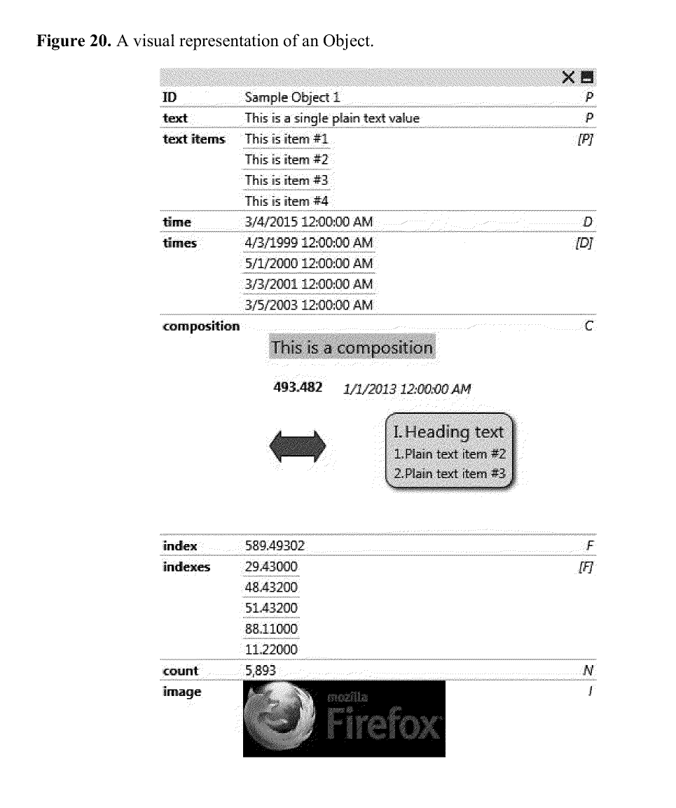

FIG. 20 illustrates a visual representation of an Object in an exemplary user interface. For the purpose of visual representation, a single letter type code is associated with each value, based on its data type (Table 8). The representation of each key-value pair is preferably delineated by a horizontal blue line. The bold text item on the left is the key, and on the far right are the type codes associated with the data type of the value. The middle item shows the visual representation of the value of the key-value pair.

TABLE 8
Single letter type codes associated with data types
for a value in a key-value pair

| | Type code for single | |
|---|---|---|
| Data Type | value | Type code for array |
| Boolean | B | [B] |
| Integer | N | [N] |
| Float | F | [F] |
| PlainText | P | [P] |
| DateTime | D | [D] |
| Image | I | [I] |
| Reference | L | [L] |
| Composition | C | [C] |
| RichText | R | [R] |
| Chart | H | [H] |
| DataTable | T | [T] |

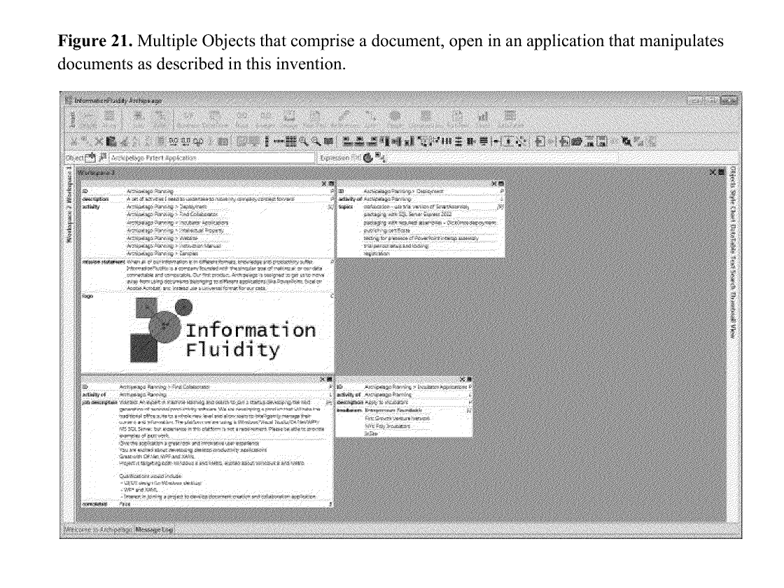

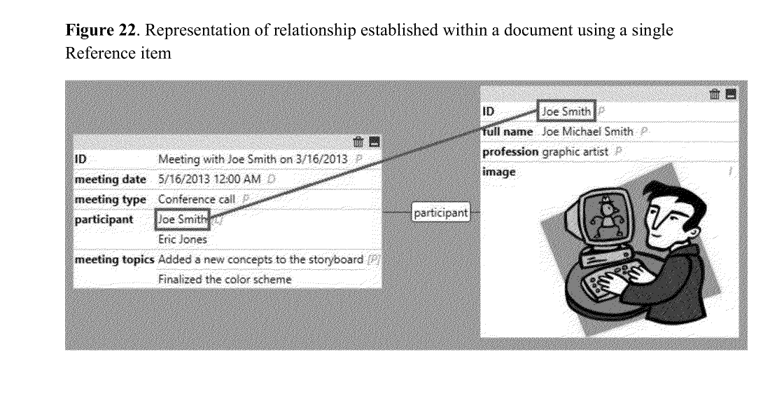

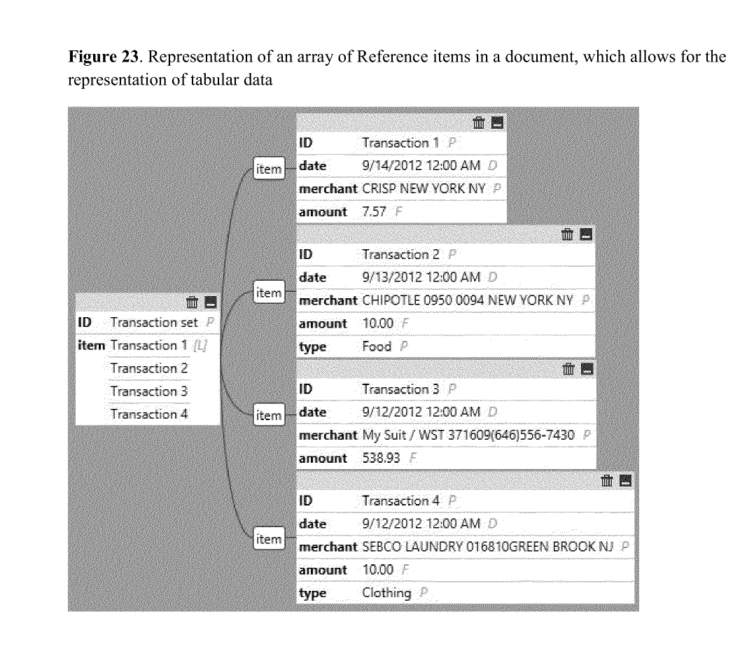

As described previously, a document consists of one or more objects, as seen in FIG. 21. Within an application that allows manipulation of documents as described in this invention, each object can be edited independently of other objects. Such an application must also allow objects from one document to be freely intermingled with objects from any other document. As such, objects are universally compatible building blocks of documents. When multiple files are loaded into the application, all their individual objects can appear within the same workspace. The user is then free to work with this combined collection, and thus this invention allows the work of multiple people and contents of multiple documents to all be accessed and worked on in one place. Relationships between objects are created through Reference items, and are preferably shown using curved lines, with a label whose text value is the key of key-value pair which has the Reference value. This is shown in FIG. 22 as a single relationship, and in FIG. 23 as an array of relationships, which allows for the representation of tabular data.

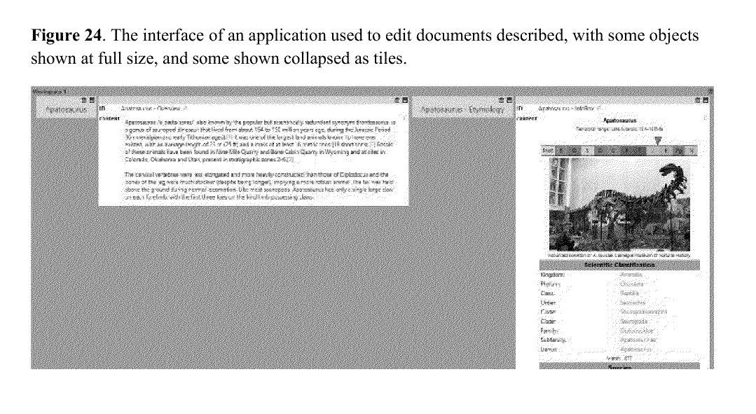

The user interface allows the user to view any combination of objects in the document at any given time, and also allows any object to be collapsed into a tile, as shown in FIG. 24. FIG. 24 illustrates an exemplary user interface of an application used to edit documents described, with some objects shown at full size, and some shown collapsed as tiles. This provides the user with significant flexibility in editing and viewing documents.

Representation of Documents in a Text Format

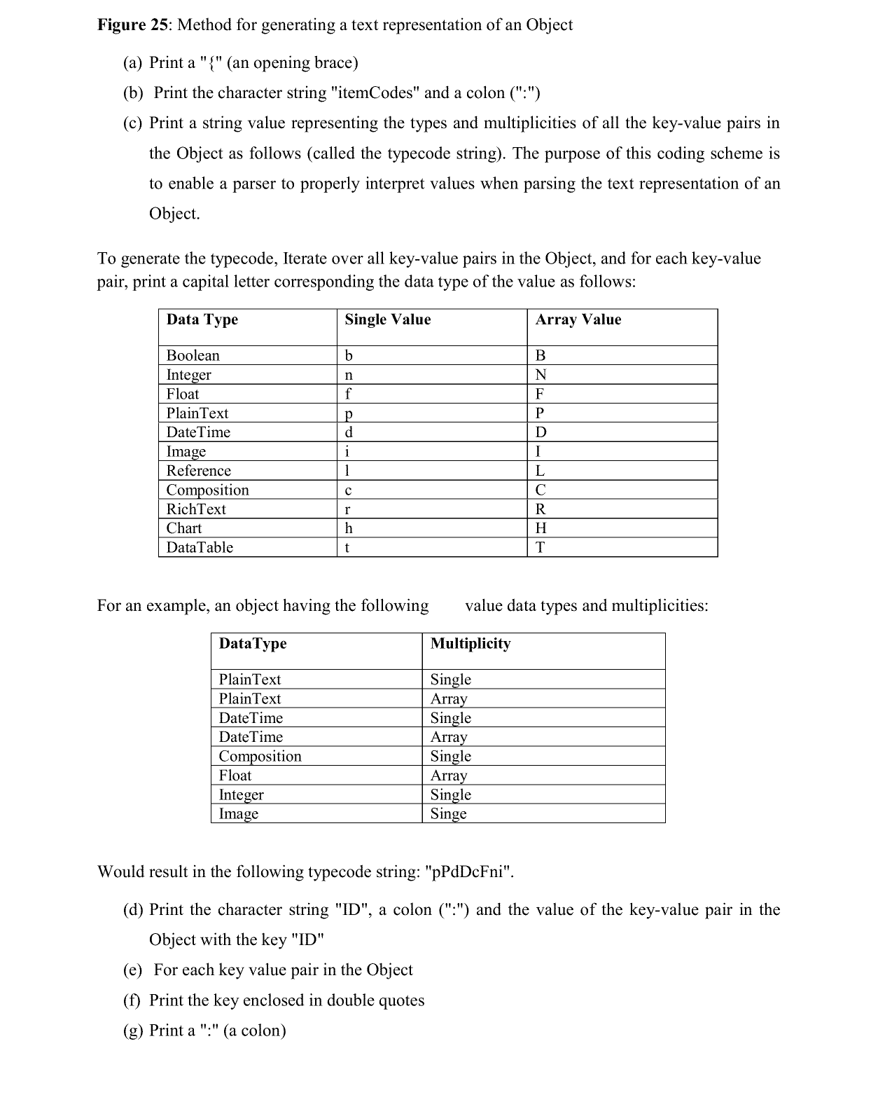

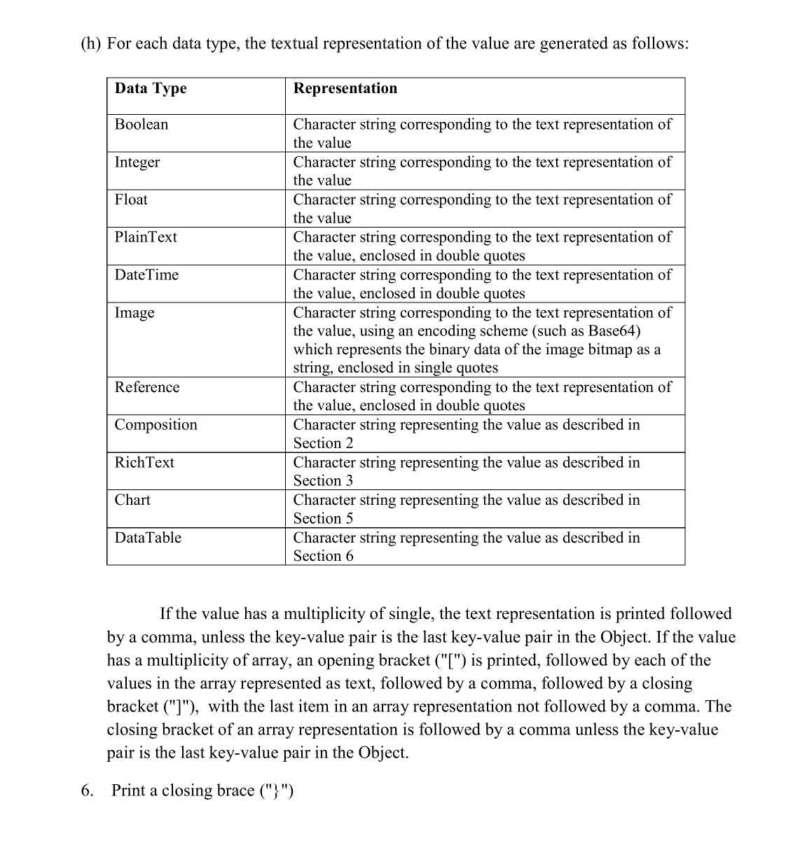

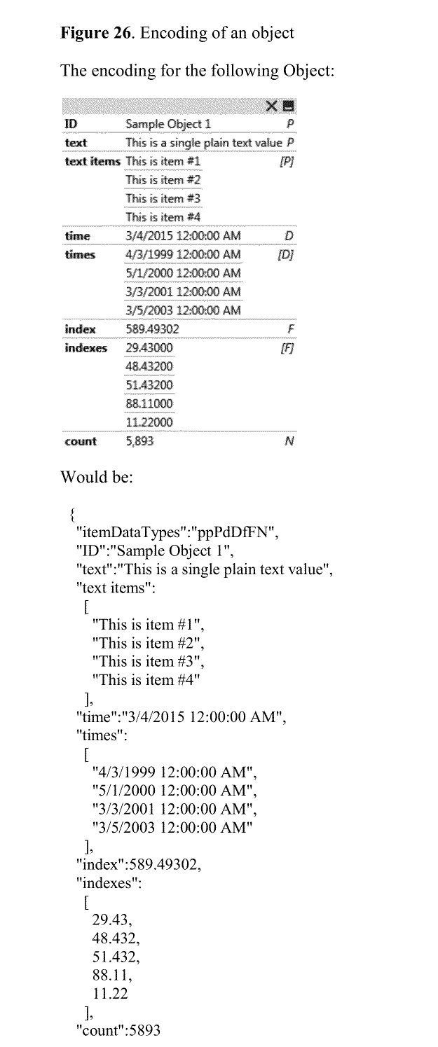

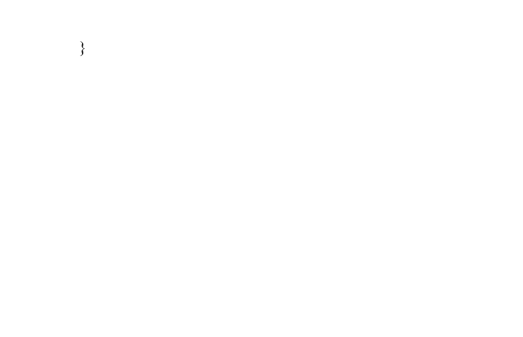

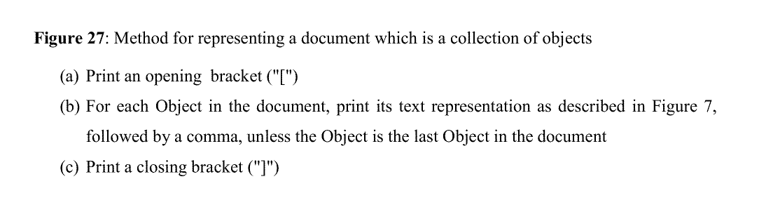

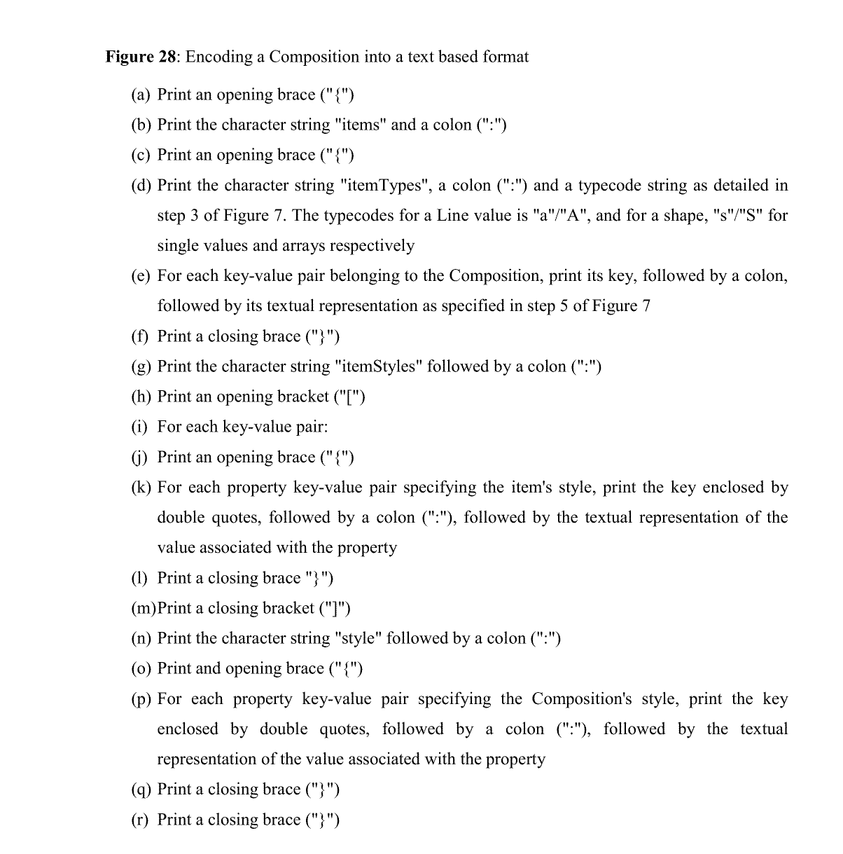

The entire document, which comprises of a collection of objects as defined previously, can be represented using a text-based format for the purposes of storing on a computer disk or to random access memory. The method for representing objects is based on the JSON (Java Script Object Notation) format and is outlined in FIG. 25, with an example shown in FIG. 26.

Since a document as described in this invention is a collection of Objects, the text representation of a document is generated as described in FIG. 27. The composite types are encoded with a text representation that contains information on the visual styling of those values, and is described in the sections for these respective types.

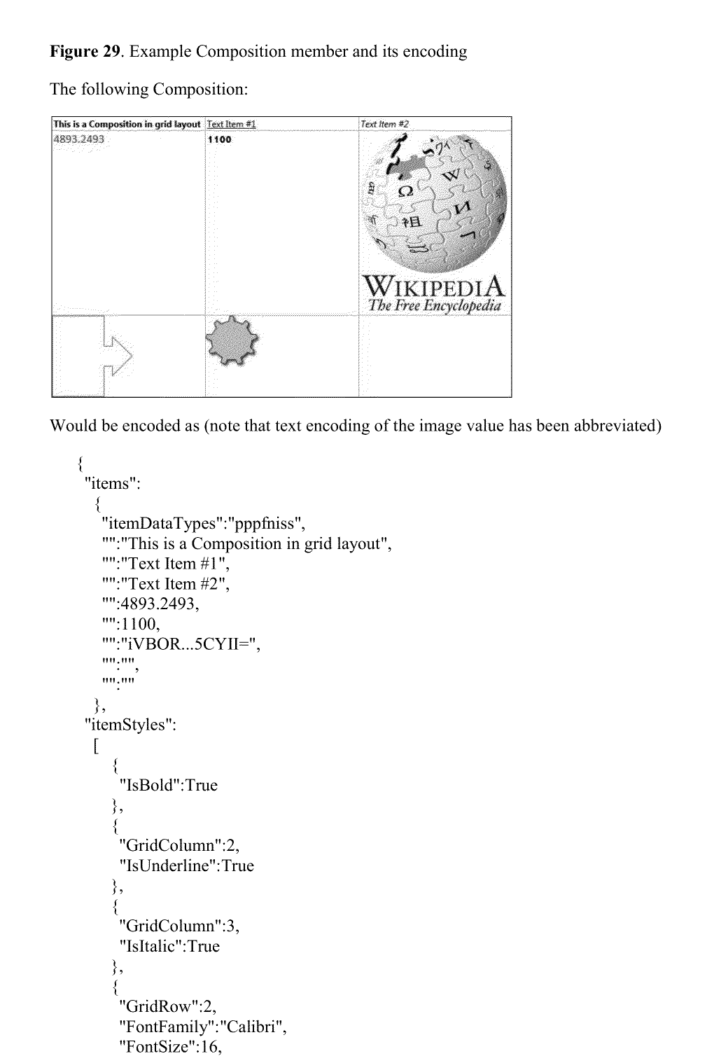

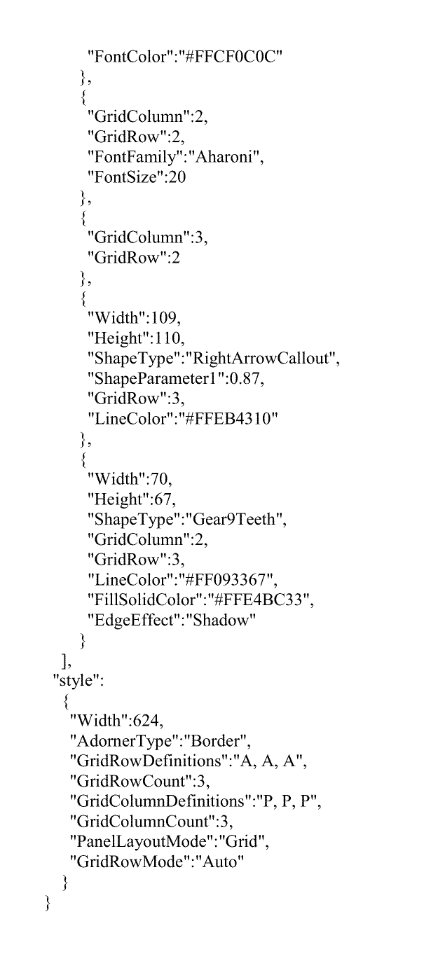

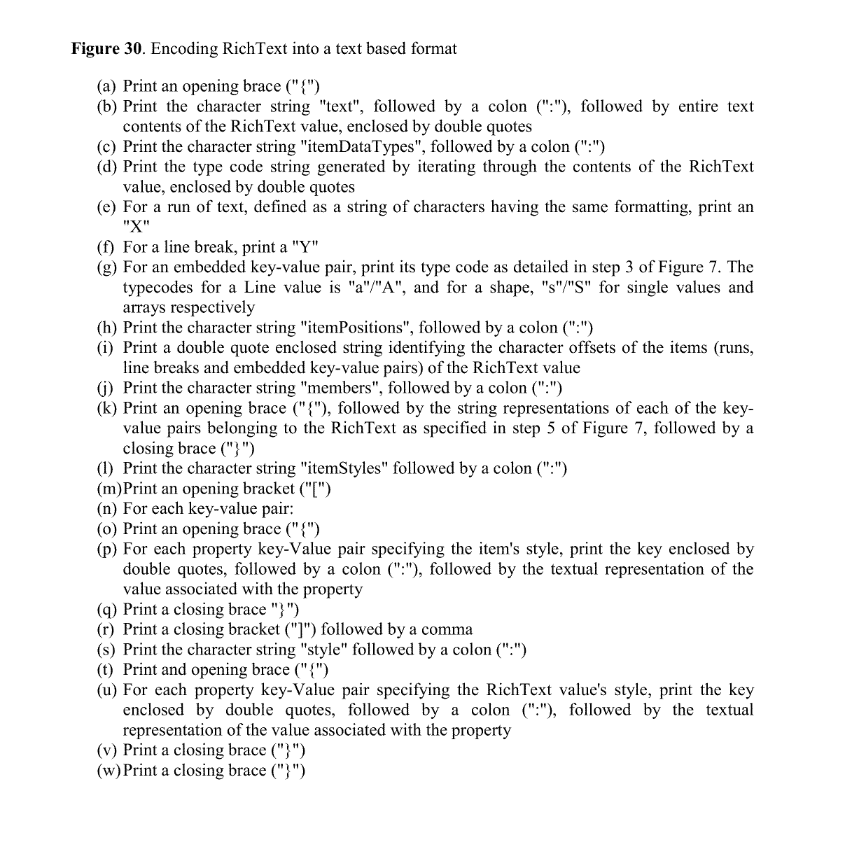

To encode a Composition into a text format for saving to file, the process described in FIG. 28 is used, with an example in FIG. 29.

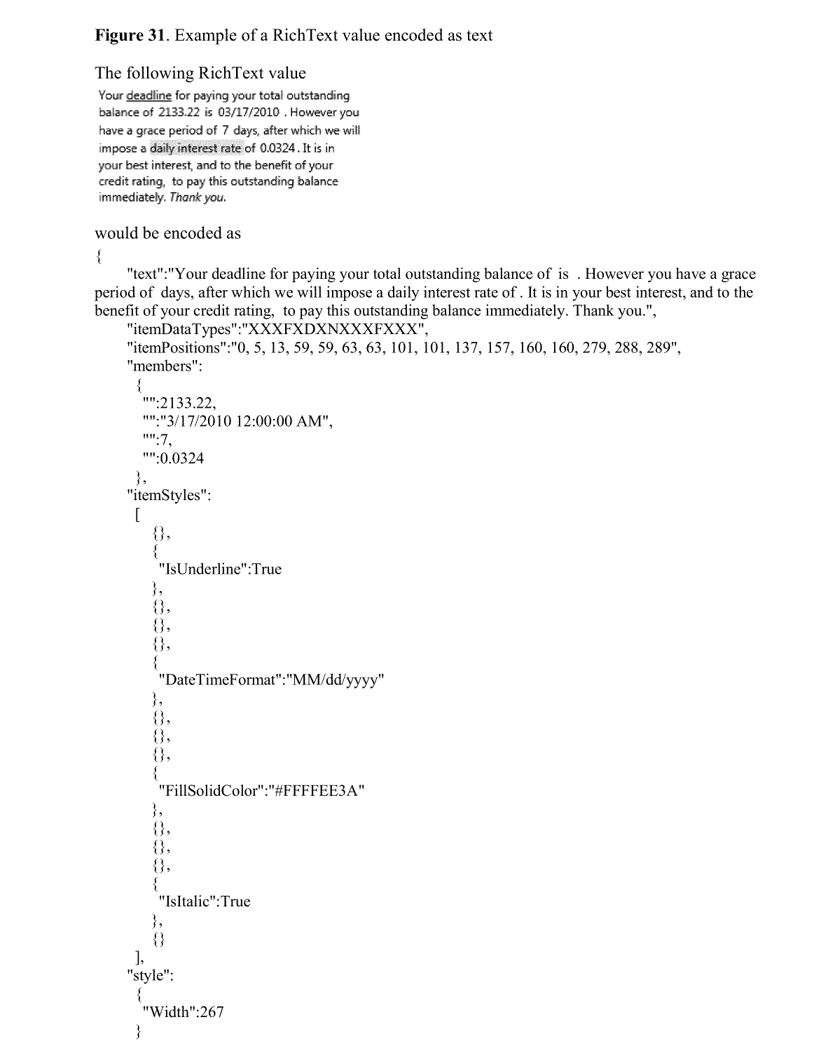

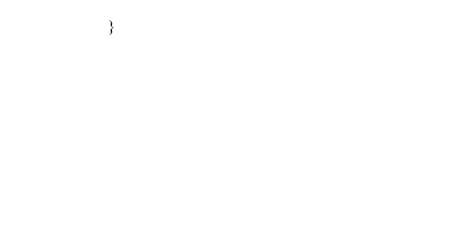

To encode a RichText value into a text format for saving to file, the process described in FIG. 30 is used, with an example in FIG. 31.

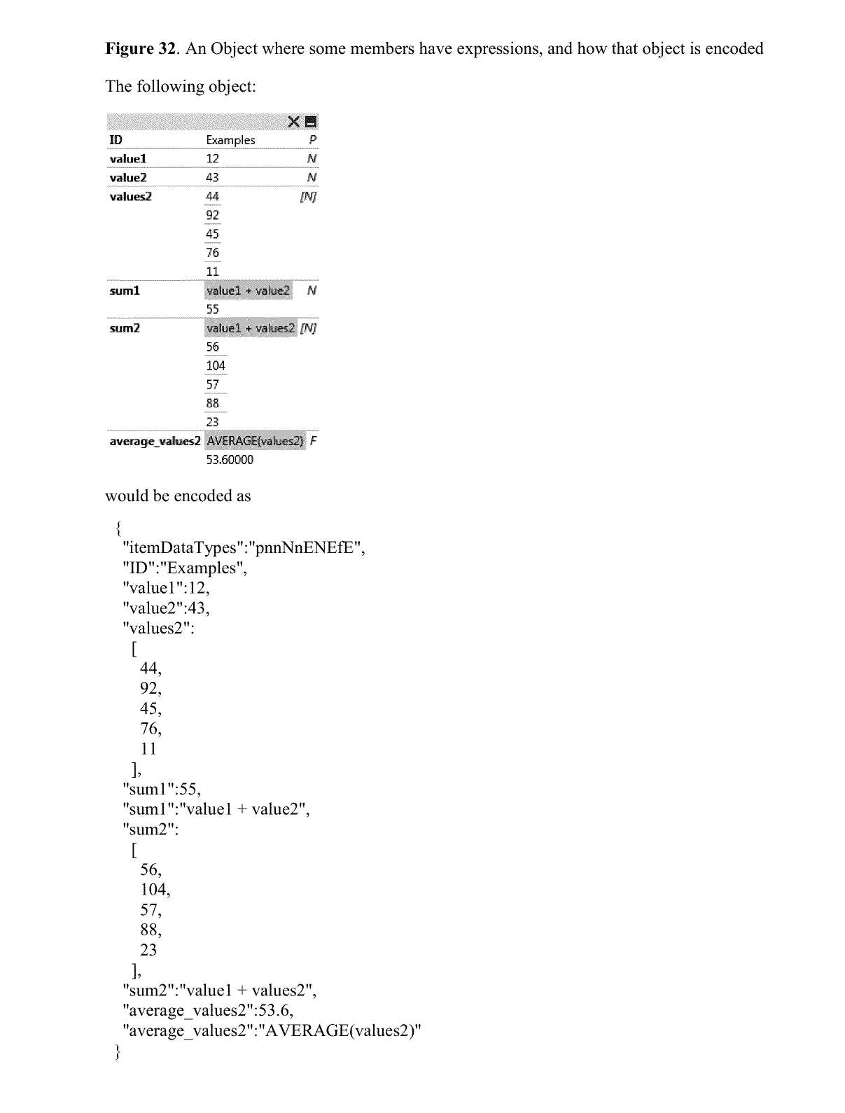

As provided in FIG. 32, when a key-value pair has an expression associated with it, the encoding of the key-value pair changes as follows:
(a) In the type code string that specifies data types of members in an object, Composition or RichText, following the member's type code, the letter “E” is printed
(b) Following the printing of the key and value as specified in previously, the key is printed again, followed by a colon, followed by the expression's text representation enclosed in double quotes

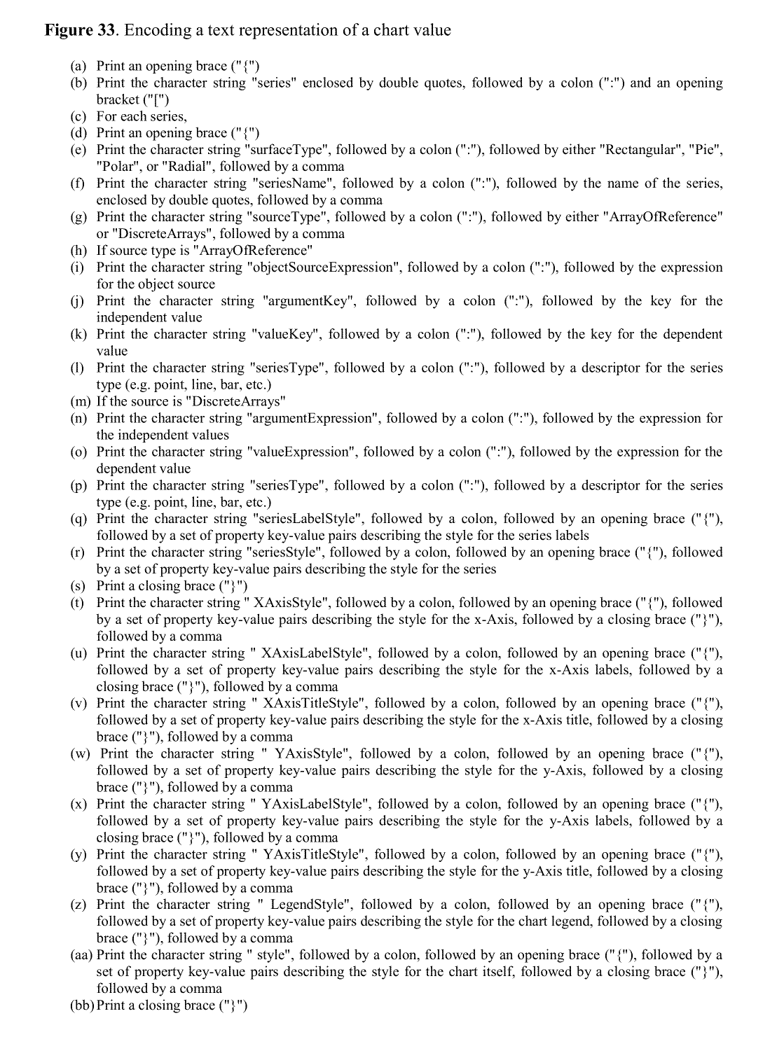

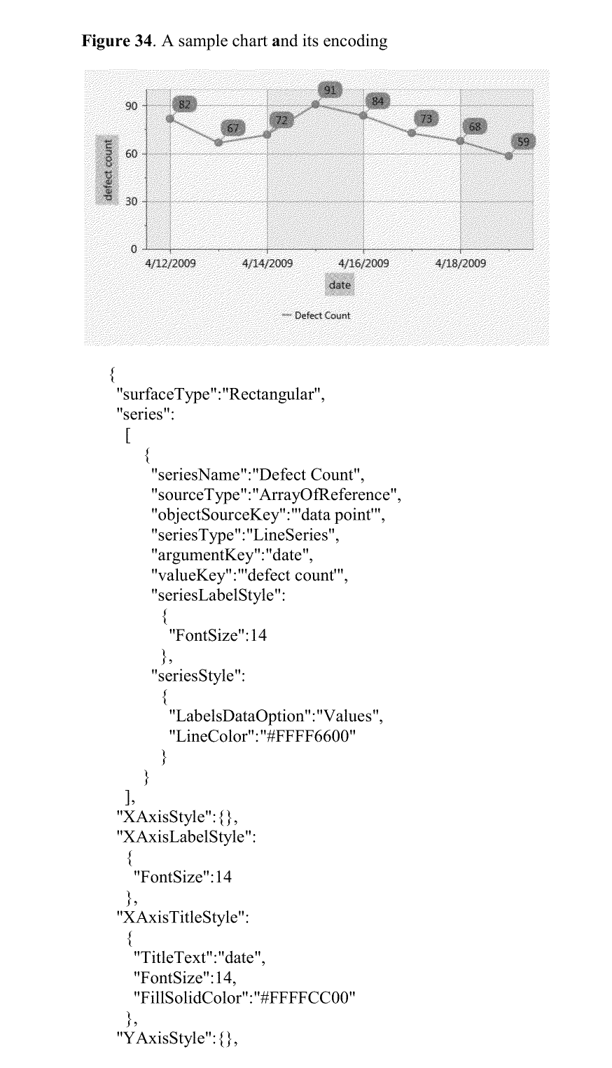

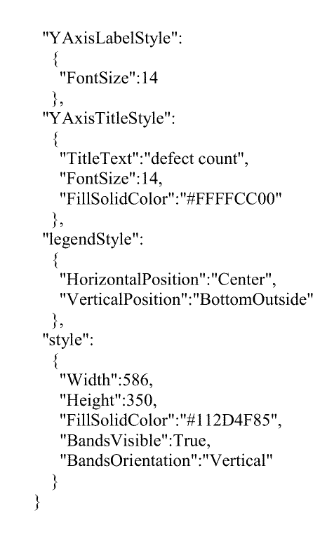

A Chart is represented as described in FIG. 33, with an example in FIG. 34.

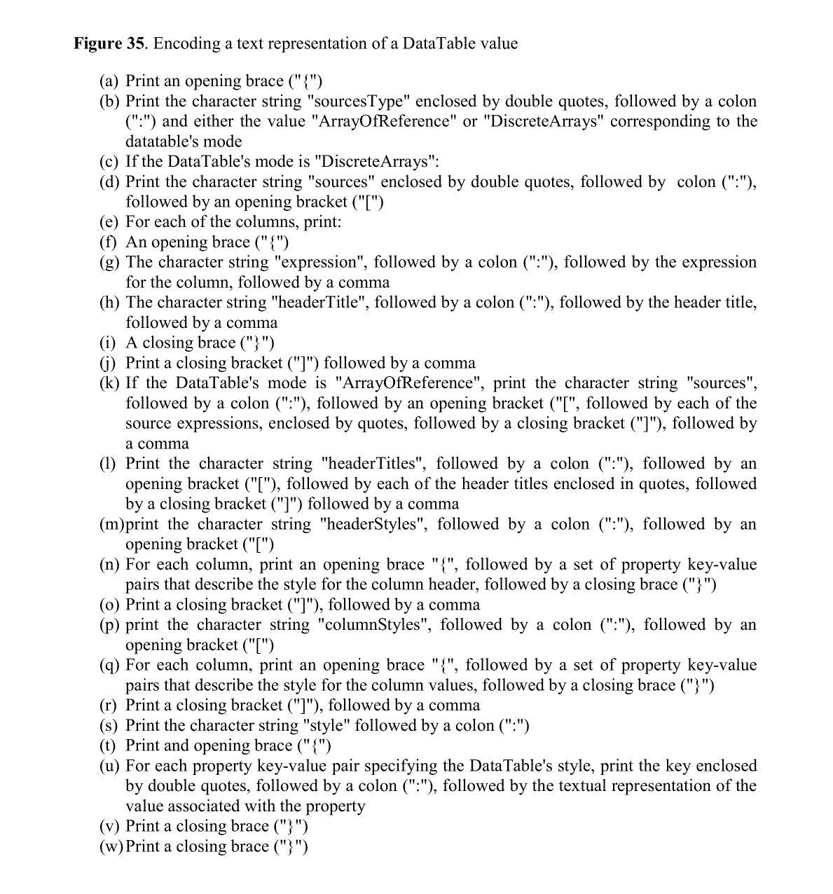

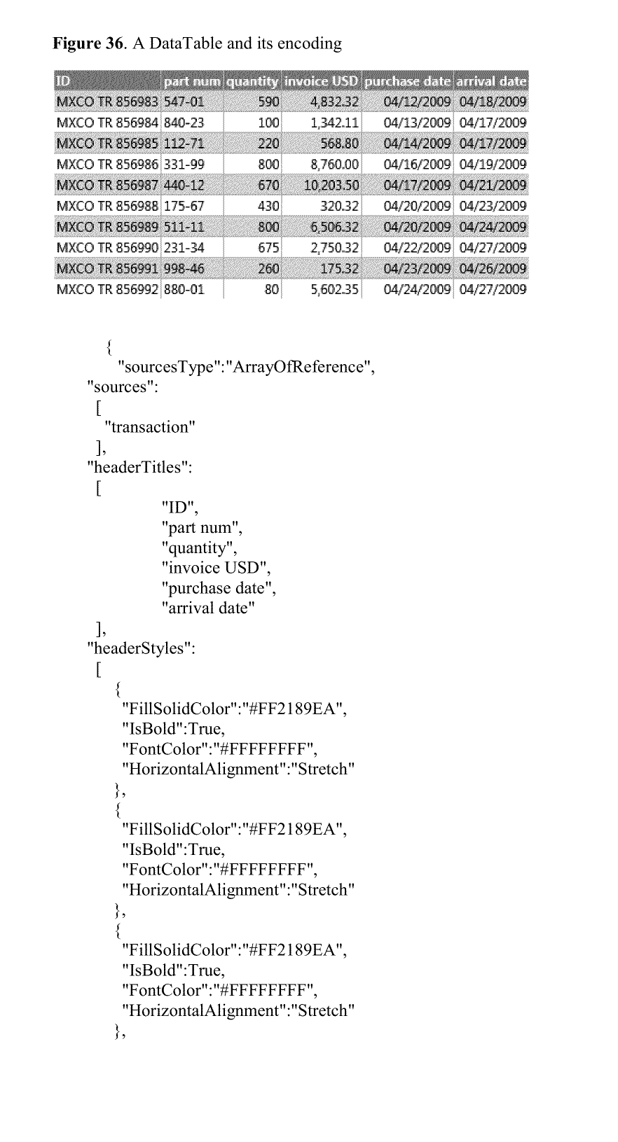

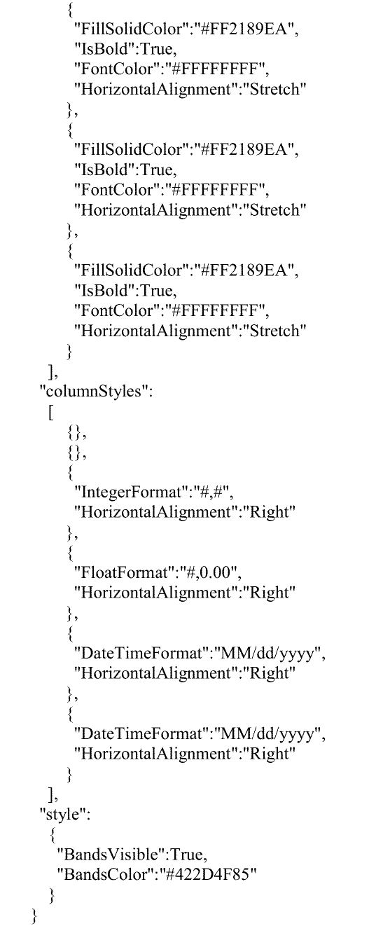

A DataTable is represented as described in FIG. 35, with an example in FIG. 36.

### Saving to Relational Database

The user may save objects to standalone files and/or to relational databases. Files are saved in a human readable, text format. Saving to a database allows a user to create a knowledgebase of nearly unlimited size and have all of his content in one place. Instead of having materials scattered in multiple files, folders and formats, the user can now search, combine, analyze and have full view of all of his information.

A relational database that will store documents described in this invention must be set up with a total of 12 tables. The first 11 tables each correspond to a data type: Boolean, DateTime, Float, Integer, Image, PlainText, Reference, Composition, RichText, Chart and DataTable. One table is used to store additional information about objects (the object information table). When an object is saved to a database, each of its member is saved in the table that corresponds to its type, with additional information about the object stored in the object information table)

The structure of a table that corresponds to a data type is shown in Table 9:

TABLE 9
Structure of a relational database table used to store key-value pairs

| Field | Field Description | Field Data Type |
|---|---|---|
| IndexNumber | Primary key for the table | Long integer (8 bytes) |
| ObjectID | Stores a unique Object ID | Long integer (8 bytes) |
| | assigned to the Object | |
| SequenceNumber | Stores an integer which specifies | integer (2 bytes) |
| | the order of the member in the | |
| | Object | |
| Key | The key of the member | string (256 bytes) |
| Value | The value of the member | depends on the data |
| | | type of the members |
| | | to be stored in the table |

The structure of the objects information table in the database is shown in Table 10. Each row of this table corresponds to an object. Every time a new object is added to or deleted from the database or an object is updated, this table is updated.

TABLE 10
The objects information relational database table

| Field | Field Description | Field Data Type |
|---|---|---|
| ObjectID | Primary key for the table and the unique | Long integer (8 bytes) |
| | identifier assigned to the Object represented | |
| | in the row | |
| ObjectIdentifierString | The value of the “ID” member of | string |
| | the Object | |
| Expressions | Stores the all of the expressions of | string |
| | members of the Object and the keys | |
| | of those members in a single text | |
| | string | |
| Dependents | A list of the Object ID numbers of | string |
| | all Objects that have members | |
| | whose values depend on members | |
| | of the Object in the row | |
| CreationDate | The date/time when the Object was | DateTime |
| | first created | |
| LastModifiedDate | The date/time when the Object was | DateTime |
| | last modified | |

What is claimed is:

1. A computer-implemented method for encoding data into structured documents comprised of modular subunits of data, comprising:
receiving, via one or more processors, data related to document content, wherein the data is organized as subunits comprising one or more key-value pairs;
storing into memory, the received document content data;
encoding, via one or more processors, the document content data according to a text format; and
storing into memory the encoded text.

2. The method of claim 1, wherein the document content data is received from user input.

3. The method of claim 1, wherein the document content data further comprises text data.

4. The method of claim 1, wherein the document content data further comprises computation data.

5. The method of claim 1, wherein the document content data further comprises at least one reference to a key-value.

6. The method of claim 1, wherein the text format is JSON.
